(19) United States
(12) Patent Application Publication
(10) Pub. No.: US 2016/0057661 A1
(43) Pub. Date: Feb. 25, 2016

(54) Dynamic Switching from SGLTE to CSFB to Improve Data Throughput

(71) Applicant: QUALCOMM Incorporated, San Diego, CA (US)

(72) Inventors: Shivank Nayak, San Diego, CA (US); Bhanu Kiran Janga, Hyderabad (IN); Ajit Gupta, Hyderabad (IN)

(21) Appl. No.: 14/462,834

(22) Filed: Aug. 19, 2014

(51) Int. Cl. H04W 36/00; H04W 64/00

(52) U.S. Cl. CPC H04W 36/0022; H04W 64/00

(57) ABSTRACT

To leverage the potential advantages of configuring an LTE radio access technology (RAT) to acquire services in a CSFB mode, methods implemented in a mobile communication device (e.g., a simultaneous GSM/LTE+GSM communication device) determine whether an available network is capable of supporting circuit-switch fallback (CSFB) operations for the LTE RAT and configure the LTE RAT to acquire services in either a CSFB mode or an SGLTE mode based on the network's capabilities. In response to determining that the mobile communication device has entered a new tracking area in the LTE RAT's network, a mobile communication device processor may determine whether a network available in the new tracking area supports CSFB operations and may configure the LTE RAT to operate in either a CSFB mode or an SGLTE mode based on that determination, thereby potentially improving the LTE RAT's overall performance and quality of services.

### BACKGROUND

Some new designs of mobile communication devices—such as smart phones, tablet computers, and laptop computers—include two or more radio access technologies (“RATs”) that enable the devices to connect to two or more radio access networks. Examples of radio access networks include Long Term Evolution (LTE), Global System for Mobile Communications (GSM), Time Division Synchronous Code Division Multiple Access (TD-SCDMA), Code Division Multiple Access 2000 (CDMA2000), and Wideband CDMA (WCDMA). Such mobile communication devices (sometimes referred to as “multi-RAT communication devices”) may also include one or more radio-frequency (RF) communication circuits or “RF resources” to provide users with access to separate networks via the two or more RATs.

Multi-RAT communication devices may include mobile communication devices (i.e., multi-Subscriber-Identity-Module (SIM), multi-active or “MSMA” communication devices) with a plurality of SIM cards that are each associated with one or more different RATs. For example, a multi-SIM-multi-active communication device may include a first SIM card/subscription that is able to simultaneously utilize an LTE RAT and a first GSM RAT (sometimes referred to a simultaneous GSM+LTE or “SGLTE” configuration or mode) and a second SIM card/subscription configured to utilize a second GSM RAT. Such communication devices are sometimes referred to as SGLTE+GSM communication devices as the first subscription may simultaneously utilize the LTE RAT and the first GSM RAT in an SGLTE configuration while the second subscription utilizes the second GSM RAT.

LTE networks provide mobile communication devices with comparatively high data throughputs that enable rich media services. However, as a data-only transport technology based on packet switching (“PS”), LTE-capable devices currently must overcome technical challenges to satisfy established quality-of-service expectations for legacy circuit-switched (“CS”) communication protocols.

One general approach to addressing the current lack of CS voice services on a LTE network involves using network signaling to determine when to switch from the PS network to the CS network (referred to herein as “circuit-switch-fallback” or “CSFB” operations). In current implementations of CSFB operations, while a mobile communication device is operating in an LTE (data connection) mode, the LTE network pages the mobile communication device in response to receiving a voice call. The mobile communication device responds with a special service request message to the LTE network, and the LTE network signals the device to move (i.e., “fall back”) to a CS network (e.g., 2G/3G) to accept the incoming call. Similarly, for outgoing calls, the same special service request is used to move the device from LTE to a CS network to place the outgoing call.

As the handling of voice traffic on LTE is evolving to meet the ever increasing availability of LTE, acquiring high-quality service data and voice services on an LTE-capable mobile communication device will continue to be a substantial design and operational challenge.

### SUMMARY

Various embodiments provide methods, devices, and non-transitory processor-readable storage media for acquiring service with a Long Term Evolution (LTE) radio access technology (RAT) associated with a first subscription.

Some embodiment methods may include identifying an available network in a first tracking area associated with a current location of the mobile communication device, determining whether the identified network supports circuit-switch-fallback (CSFB) operations for the LTE RAT, and acquiring service from the identified network with the LTE RAT in one of a CSFB mode and a simultaneous Global System for Mobile Communications (GSM)/LTE (SGLTE) mode based at least in part on the determination of whether the identified network supports CSFB operations.

In some embodiments, the mobile communication device may be a multi-SIM, multi-active communication device that simultaneous supports GSM/LTE plus GSM network connectivity.

Some embodiment methods may include determining whether a second subscription is available in response to determining that the identified network supports CSFB operations for the LTE RAT, and in some embodiments, acquiring service from the identified network with the LTE RAT in one of a CSFB mode and an SGLTE mode may include acquiring service with the LTE RAT in an SGLTE mode from the identified network in response to determining that the second subscription is not available.

Some embodiment methods include determining whether the mobile communication device has entered a second tracking area, identifying a network that is available in the second tracking area in response to determining that the mobile communication device has entered the second tracking area, determining whether the available network in the second tracking area supports CSFB operations for the LTE RAT, and acquiring service from the available network in the second tracking area with the LTE RAT in one of a CSFB mode and an SGLTE mode based at least in part on the determination of whether the available network in the second tracking area supports CSFB operations.

In some embodiments, acquiring service from the identified network with the LTE RAT in one of a CSFB mode and an SGLTE mode based at least in part on the determination of whether the identified network supports CSFB operations may include acquiring service from the identified network with the LTE RAT in a CSFB mode in response to determining that the identified network supports CSFB operations for the LTE RAT.

In some embodiments, acquiring service from the identified network with the LTE RAT in one of a CSFB mode and an SGLTE mode based at least in part on the determination of whether the identified network supports CSFB operations may include acquiring service from the identified network with the LTE RAT in an SGLTE mode in response to determining that the identified network does not support CSFB operations for the LTE RAT.

Some embodiment methods may include determining whether the LTE RAT is able to receive packet-switch services and determining whether a Time Division Synchronous Code Division Multiple Access (TD-SCDMA) RAT associated with the first subscription is able to receive service in response to determining that the LTE RAT is unable to receive packet-switch services.

Some embodiment methods may include suspending acquisition of circuit-switch services with a GSM RAT associated with the first subscription and acquiring circuit-switch services and packet-switch services with the TD-SCDMA RAT in response to determining that the TD-SCDMA RAT is able to receive service.

Some embodiment methods may include determining whether the LTE RAT is again able to receive packet-switch services and performing operations in response to determining that the LTE RAT is again able to receive packet-switch services, wherein the operations may include discontinuing acquisition of circuit-switch services and packet-switch services with the TD-SCDMA RAT, reacquiring circuit-switch services with the GSM RAT, and reacquiring packet-switch services with the LTE RAT.

Some embodiment methods may include acquiring circuit-switch services and packet-switch services with a GSM RAT associated with the first subscription in response to determining that the TD-SCDMA RAT is unable to receive service.

Some embodiment methods may include determining whether the LTE RAT is again able to receive packet-switch services and performing operations in response to determining that the LTE RAT is again able to receive packet-switch services, wherein the operations may include discontinuing acquisition of packet-switch services with the GSM RAT and reacquiring packet-switch services with the LTE RAT.

Some embodiment methods may include determining whether acquiring service with the LTE RAT in a CSFB mode is preferred. In some embodiments, acquiring service from the identified network with the LTE RAT in one of a CSFB mode and an SGLTE mode may include acquiring service from the identified network with the LTE RAT in an SGLTE mode in response to at least one of determining that acquiring service with the LTE RAT in a CSFB mode is not preferred and determining that the identified network does not support CSFB operations for the LTE RAT.

In some embodiments, acquiring service from the identified network with the LTE RAT in one of a CSFB mode and an SGLTE mode may include acquiring service from the identified network with the LTE RAT in a CSFB mode in response to determining that the identified network supports CSFB operations for the LTE RAT and that acquiring service with the LTE RAT is a CSFB mode is preferred.

In some embodiments, determining whether the identified network supports CSFB operations for the LTE RAT may include determining whether the first tracking area is included in a first list of tracking areas that do not support CSFB operations, and acquiring service from the identified network with the LTE RAT in one of a CSFB mode and an SGLTE mode may include acquiring service from the identified network with the LTE RAT in an SGLTE mode in response to determining that the first tracking area is included in the first list of tracking areas.

In some embodiments, determining whether the identified network supports CSFB operations for the LTE RAT may include determining whether the first tracking area is included in a second list of tracking areas that support CSFB operations, and acquiring service from the identified network with the LTE RAT in one of a CSFB mode and an SGLTE mode may include acquiring service from the identified network with the LTE RAT in a CSFB mode in response to determining that the first tracking area is included in the second list of tracking areas.

In some embodiments, determining whether the identified network supports CSFB operations for the LTE RAT may include attempting CSFB registration with the identified network for the LTE RAT in response to determining that the first tracking area is not included in the first list of tracking areas and the second list of tracking areas and determining whether the CSFB registration attempt was successful.

In some embodiments, acquiring service from the identified network with the LTE RAT in one of a CSFB mode and an SGLTE mode may include adding the first tracking area to the first list of tracking areas and acquiring service from the identified network with the LTE RAT in an SGLTE mode in response to determining that the CSFB registration attempt was unsuccessful and adding the first tracking area to the second list of tracking areas and acquiring service from the identified network with the LTE RAT in a CSFB mode in response to determining that the CSFB registration attempt was successful.

Some embodiment methods may include determining a time at which the first tracking area is added to the first list of tracking areas in response to adding the first tracking area to the first list of tracking areas, waiting a predetermined period of time from the time at which the first tracking area is added to the first list of tracking areas, and removing the first tracking area from the first list of tracking areas after waiting the predetermined period of time.

In some embodiments, determining whether the identified network supports CSFB operations for the LTE RAT may include determining whether the first tracking area is included in a list of tracking areas that support CSFB operations, and acquiring service from the identified network with the LTE RAT in one of a CSFB mode and an SGLTE mode may include acquiring service from the identified network with the LTE RAT in a CSFB mode in response to determining that the first tracking area is included in the list of tracking areas.

Some embodiment methods may include acquiring service from the identified network with the LTE RAT in an SGLTE mode and determining whether a call has started on a second GSM RAT associated with a second subscription, and in some embodiments, determining whether the identified network supports CSFB operations for the LTE RAT may include determining whether the identified network supports CSFB operations for the LTE RAT in response to determining that a call has started on the second GSM RAT.

In some embodiments, acquiring service from the identified network with the LTE RAT in one of a CSFB mode and an SGLTE mode based at least in part on the determination of whether the identified network supports CSFB operations may include maintaining service with the LTE RAT in an SGLTE mode in response to determining that a call has started on the second GSM RAT and determining that the identified network does not support CSFB operations.

In some embodiments, acquiring service from the identified network with the LTE RAT in one of a CSFB mode and an SGLTE mode based at least in part on the determination of whether the identified network supports CSFB operations may include acquiring service with the LTE RAT in a CSFB mode in response to determining that a call has started on the second GSM RAT and that the identified network supports CSFB operations.

Some embodiment methods may include determining whether the call on the second GSM RAT has ended and reacquiring service with the LTE RAT in an SGLTE mode in response to determining that the call on the second GSM RAT has ended.

Some embodiment methods may include suspending acquisition of service with a first GSM RAT associated with the first subscription in response to determining that a call on the second GSM RAT has started and resuming acquisition of service with the first GSM RAT in response to determining that the identified network does not support CSFB operations.

Some embodiment methods may include deactivating the first GSM RAT in response to determining that a call has started on the second GSM RAT and that the identified network supports CSFB operations, determining whether the call on the second GSM RAT has ended, and reactivating the first GSM RAT and reacquiring service with the first GSM RAT in response to determining that the call on the second GSM RAT has ended.

Various embodiments may include a mobile communication device configured with processor-executable instructions to perform operations of the methods described above.

Various embodiments may include a mobile communication device having means for performing functions of the operations of the methods described above.

Various embodiments may include non-transitory processor-readable media on which are stored processor-executable instructions configured to cause a processor of a mobile communication device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with various embodiments.

FIG. 2 is a component block diagram of a mobile communication device according to various embodiments.

FIG. 3 is a component block diagram of radio-frequency resources included on an SGLTE+GSM communication device according to various embodiments.

FIG. 4 is a process flow diagram illustrating a method for acquiring service with an LTE RAT in either a CSFB mode or an SGLTE mode based on whether an available network in the mobile communication device's current location supports CSFB operations, according to various embodiments.

FIG. 5 is a process flow diagram illustrating another method for acquiring service with an LTE RAT in either a CSFB mode or an SGLTE mode based on whether an available network supports CSFB operations according to various embodiments.

FIG. 6 is a process flow diagram illustrating a method for determining whether a network supports CSFB operations according to various embodiments.

FIG. 7 is a process flow diagram illustrating a method for managing a list of tracking areas that do not support CSFB operations according to various embodiments.

FIG. 8 is a table illustrating RAT configurations on a conventional SGLTE+GSM communication device.

FIG. 9 is a table illustrating RAT configurations on an SGLTE+GSM communication device according to various embodiments.

FIG. 10 is a process flow diagram illustrating a method for temporarily switching an LTE RAT from operating in an SGLTE mode to a CSFB mode according to various embodiments.

FIG. 11 is a process flow diagram illustrating another method for temporarily switching an LTE RAT from operating in an SGLTE mode to a CSFB mode according to various embodiments.

FIG. 12 is a process flow diagram illustrating a method for acquiring services with another RAT in response to determining that an LTE RAT operating in an SGLTE mode is unable to receive PS data services according to various embodiments.

FIG. 13 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with one or more networks, the terms “SIM” and “subscription” are used interchangeably and are used herein as a shorthand reference to refer to the communication service(s) associated with and enabled by the information stored in a particular SIM as the SIM and the communication network(s), as well as the services and subscriptions supported by the network(s), correlate to one another.

As used herein, the terms “mobile communication device” and “SGLTE+GSM communication device” are used interchangeably and refer to any one or all of cellular telephones, smart phones, personal or mobile multi-media players, personal data assistants, laptop computers, personal computers, tablet computers, smart books, palm-top computers, wireless electronic mail receivers, multimedia Internet enabled cellular telephones, wireless gaming controllers, and similar personal electronic devices that include a programmable processor, memory, and circuitry for connecting to at least two mobile communication networks. Various embodiments may be useful in mobile communication devices, such as smart phones, and so such devices are referred to in the descriptions of various embodiments. However, various embodiments may be useful in any electronic devices that may individually maintain a plurality of radio access technologies (RATs), such as an LTE RAT, capable of performing circuit-switch-fallback operations.

As described, an LTE RAT provides relatively high-quality, PS data services but currently lacks the capacity to acquire/provide CS voice services, such as voice calls, Short Message Service (SMS) messages, etc. Thus, in conventional mobile communication devices, the LTE RAT typically operates in conjunction with another RAT capable of acquiring CS voice services (e.g., a GSM RAT). For example, on an SGLTE+GSM communication device, a first subscription/SIM receives PS data services via the LTE RAT of the first RF resource (when an LTE network is available) and CS voice services via a first GSM RAT of the second RF resource, and a second subscription/SIM receives CS and PS services via a second GSM RAT of the second RF resource. In some instances, the first GSM RAT of the first subscription or the second GSM RAT of the second subscription may share the first RF resource with the LTE RAT in situations in which the second RF resource is already in use by a third GSM RAT associated with a third subscription.

SGLTE+GSM communication devices typically exhibit superior throughput and performance over other conventional mobile devices in certain circumstances. Specifically, the first subscription's LTE RAT is capable of high-data throughput as long as the LTE RAT has exclusive access to the first RF resource because the LTE RAT does not have to compete with the first and second GSM RATs for access to the first RF resource. While usually providing a high performance and throughput, SGLTE+GSM communication devices operating in an SGLTE mode typically consume a comparatively large amount of power to facilitate the use of both the LTE RAT and the first GSM RAT for the first subscription.

In other circumstances, SGLTE+GSM communication devices experience a substantial drop in performance that may not justify the comparatively large amount of power needed to support both the LTE RAT and the first GSM RAT for the first subscription. For example, when the second GSM RAT of the second subscription requires exclusive access to the second RF resource (e.g., while the second GSM RAT is engaged in an active voice call), the LTE RAT must share the first RF resource with first GSM RAT. While the LTE RAT and first GSM RAT share the first RF resource, the first GSM RAT may periodically need to take access to the first RF resource away from the LTE RAT to perform network paging operations or other idle-standby mode operations (e.g., power monitoring). As a result, the first GSM RAT periodically competes with the LTE RAT for access to the first RF resource, thereby degrading the LTE RAT's performance and data throughput.

As described, some networks currently support CSFB operations that enable an LTE RAT to acquire PS data services at a high-throughput while simultaneously receiving paging messages from a CS network. Thus, on an SGLTE+GSM communication device, the first GSM RAT may be suspended/deactivated while the LTE RAT operates in a CSFB mode as the LTE RAT is capable of both receiving PS data services and monitoring CS paging messages. As a result of configuring the LTE RAT to operate in a CSFB mode, the SGLTE+GSM communication device may achieve performance that is comparable to when the LTE RAT operates in SGLTE mode. Further, because the first GSM RAT is suspended/deactivated, the LTE RAT's operating in the CSFB mode may require less power than operating in an SGLTE mode.

In overview, to leverage the potential advantages of configuring an LTE RAT to acquire services in a CSFB mode, various embodiments provide methods implemented in a mobile communication device (e.g., an SGLTE+GSM communication device) for determining whether an available network is capable of supporting CSFB operations for the LTE RAT and configuring the LTE RAT to acquire services in either a CSFB mode or an SGLTE mode based on the available network's capabilities. Specifically, in response to determining that the mobile communication device has entered a new tracking area in the LTE network, a processor of the mobile communication device may determine whether a network available in the new tracking area supports CSFB operations and may configure the LTE RAT to operate in either a CSFB mode or an SGLTE mode based on that determination, thereby potentially improving the LTE RAT's overall performance and quality of services.

In various embodiments, the mobile communication device may support multiple subscriptions/SIMs and multiple RF resources. In such embodiments, a first subscription implemented on the mobile communication device may simultaneously utilize both an LTE radio access technology (“RAT”) and a first GSM RAT (sometimes referred to as a “simultaneous GSM/LTE” or “SGLTE” configuration or mode), and a second subscription may independently utilize a second GSM RAT. In other words, an LTE RAT operating in an “SGLTE mode” may utilize a first RF resource at the same time that the first GSM RAT shares either the first RF resource with the LTE RAT or the second RF resource with the second GSM RAT. For example, the LTE RAT may receive PS data services via the first RF resource while the first GSM RAT receives CS paging messages via the second RF resource.

In some embodiments, the LTE RAT may alternatively operate in a “CSFB mode.” While operating in a CSFB mode, the LTE RAT receives PS data services and CS voice paging messages on the first RF resource, and the first GSM RAT is suspended or disabled until CS voice services are needed (e.g., an incoming or outgoing CS voice call). For example, the LTE RAT may receive a CS paging message indicating that a CS voice call is pending, and the mobile communication device may resume/reactivate the first GSM in order to receive the voice call. In some embodiments, the device processor may acquire service with the LTE RAT in a CSFB mode in response to determining that an available network supports CSFB operations.

In some embodiments, the device processor may determine whether an available network supports CSFB operations by attempting CSFB registration with the network. For example, the device processor may register for PS data services and CS paging services with an available LTE network. In response to determining that the available network supports CSFB operations (i.e., that the network is capable of sending CS paging messages via LTE), the device processor may acquire service with the LTE RAT in a CSFB mode, such as by receiving PS data services and CS paging and SMS messages via the LTE RAT. In response to determining that the available network does not support CSFB operations, the device processor may acquire service with the LTE RAT in an SGLTE mode. In other words, in the event that CSFB is not available, the device processor may acquire PS data services with the LTE RAT and, simultaneously, receive CS voice services via the first GSM RAT. In some embodiments, because the device processor may switch the LTE RAT between a CSFB mode and an SGLTE mode, the device processor may enable the mobile communication device to operate in a variety of networks that may support CSFB operations, may partially support CSFB operations, or may not support CSFB operations.

In some embodiments, the device processor may determine whether acquiring service with the LTE RAT in the CSFB mode is preferred, such as based on a user input or on resources currently available on the mobile communication device. In response to determining that operating in the CSFB mode is preferred, the device processor may initially attempt to acquire service with the LTE RAT in the CSFB mode. In response to determining that operating in the CSFB mode is not preferred, the device processor may instead attempt to acquire service with the LTE RAT in an SGLTE mode.

In some embodiments, the device processor may determine whether an available network supports CSFB operations by referencing one or more lists of tracking areas (i.e., discrete geographical areas in the LTE RAT's network) that have been previously associated with LTE networks that support or do not support CSFB operations. Specifically, the device processor may determine whether the tracking area in the mobile communication device's current geographical location is included in a list of tracking areas associated with networks that support CSFB operations, and the device processor may acquire services with the LTE RAT in the CSFB mode in the event that the current tracking area is included in that list. In response to determining that the current tracking area is included in a list of tracking areas that do not support CSFB operations, the device processor may acquire service with the LTE RAT in an SGLTE mode without attempting to register for CSFB service. In the event that the current tracking area is not included in either list, the device processor may attempt CSFB registration and may include the current tracking area in one of the lists based on the results of the CSFB registration attempt.

In some embodiments, the device processor may periodically remove tracking areas from the list of tracking areas that do not support CSFB operations. This enables mobile communication devices to periodically perform operations to determine whether tracking areas support CSFB operations because network operator may upgrade their networks in some tracking areas to support CSFB operations. Thus, by occasionally purging the list of tracking areas that do not support CSFB operations, the device processor may check whether those networks now support CSFB by re-attempting CSFB registration.

In some embodiments in which service is acquired with the LTE RAT in an SGLTE mode (e.g., by default), the device processor may monitor for the second GSM RAT to initiate a call on the second RF resource. In response to detecting such a call, the device processor may switch the LTE RAT to a CSFB mode (in the event that the LTE RAT's current network supports CSFB operations) and may disable the first GSM RAT until the second GSM RAT finishes the call, at which point the device processor may switch the LTE RAT back to an SGLTE mode and reactivate the first GSM RAT of the second RF resource. As a result, the LTE RAT's overall performance and data throughput during the second GSM RAT's call will be improved as the LTE RAT is able to avoid sharing the first RF resource with the first GSM RAT during the second GSM RAT's call.

In some embodiments in which the LTE RAT is acquiring services in an SGLTE mode, the device processor may determine whether the LTE RAT is out of service and unable to receive PS data services, such as when the mobile communication device moves out of an LTE network's coverage area. For example, the device processor may monitor the received signal strength of the LTE's network. In response to determining that the LTE RAT is out of service (e.g., out of the LTE network's coverage area), the device processor may attempt to switch from receiving PS data services with the LTE RAT and CS voice services with the first GSM RAT to receiving both CS and PS services with a TD-SCDMA or “TDS” RAT. In the event that the TDS RAT is unable to receive service, the device processor may switch from receiving PS services with the LTE RAT and CS services with the first GSM RAT to receiving both PS and CS services with the first GSM RAT. In response to determining that the LTE RAT is again able to receive PS data services, the device processor may resume receiving PS data services with the LTE RAT and CS voice services with the first GSM RAT. For example, in response to determining that the mobile communication device has moved back into the coverage area of an LTE network or that the LTE RAT is no longer out of service, the device processor may resume receiving PS data services with the LTE RAT and CS voice services with the first GSM RAT.

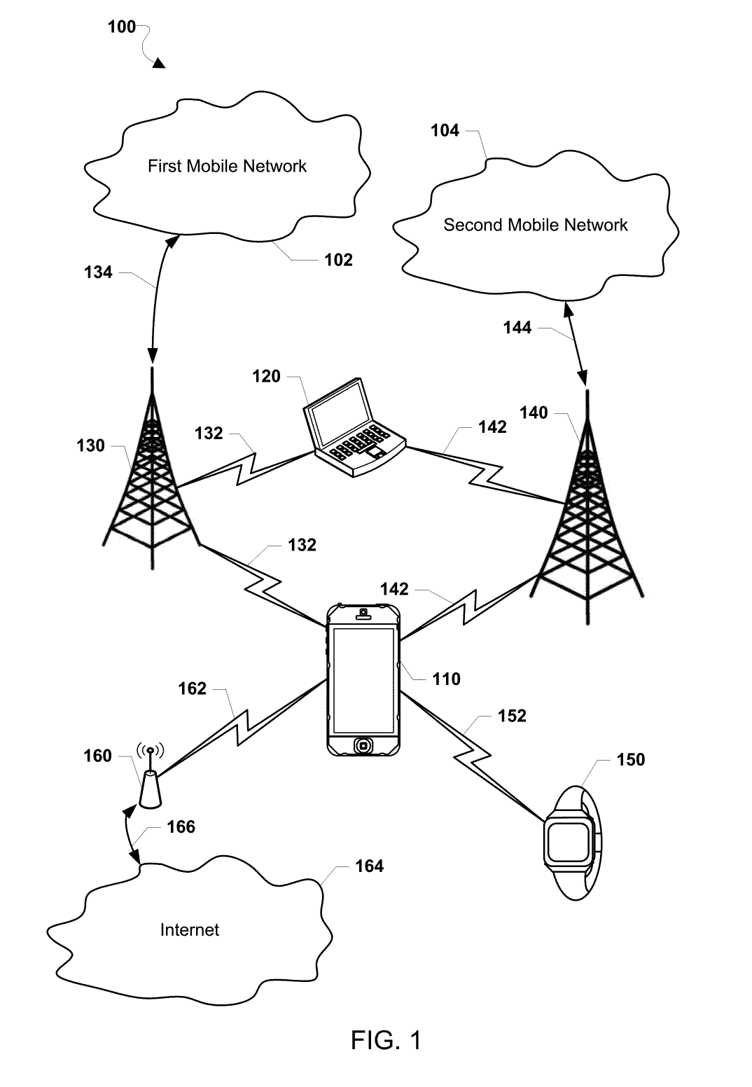

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as 4G, 3G, CDMA, TDMA, WCDMA, GSM, LTE, TD-SCDMA and other mobile telephony communication technologies.

While the mobile communication devices 110, 120 are shown connected to two mobile networks 102, 104, in some embodiments (not shown), the mobile communication devices 110, 120 may include two or more subscriptions to two or more mobile networks and may connect to those subscriptions in a manner similar to those described above.

In some embodiments, the first mobile communication device 110 may establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

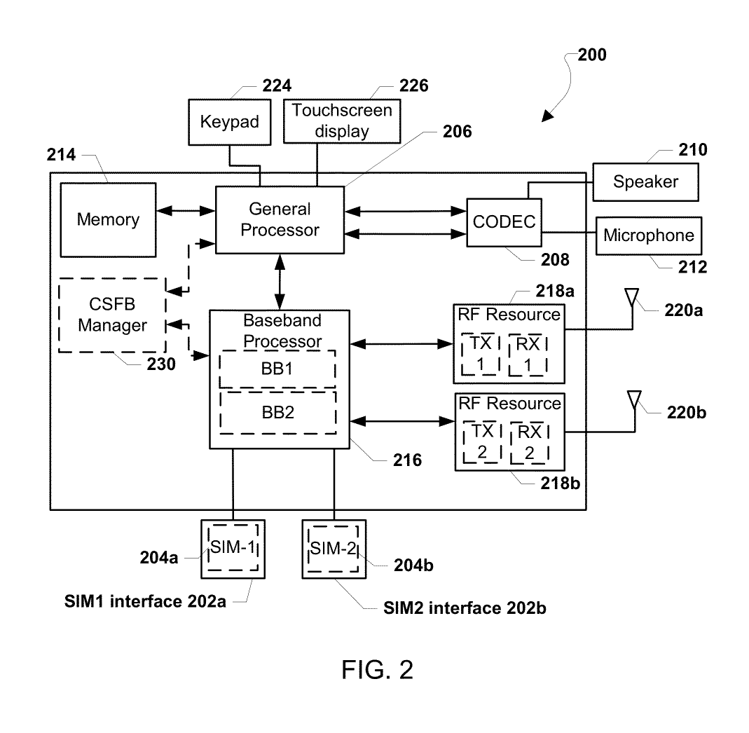

FIG. 2 is a functional block diagram of a mobile communication device 200 suitable for implementing various embodiments. According to various embodiments, the mobile communication device 200 may be similar to one or more of the mobile communication devices 110, 120 as described with reference to FIG. 1. With reference to FIGS. 1-2, the mobile communication device 200 may include a first SIM interface 202a, which may receive a first identity module SIM-1 204a that is associated with a first subscription. The mobile communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the mobile communication device, and thus need not be a separate or removable circuit, chip or card.

A SIM used in various embodiments may contain user account information, an international mobile subscriber identity (IMSI), a set of SIM application toolkit (SAT) commands and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification.

The mobile communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure. In some embodiments, the memory 214 may also store one or more look-up tables, lists, or various other data structures that may be referenced to determine whether a tracking area in the current location of the mobile communication device 200 is capable of supporting CSFB operations. For example, a list of tracking areas that do not support CSFB operations (and/or a list of tracking areas that does support CSFB operations) stored in the memory 214 may be used to quickly and efficiently determine that an LTE RAT may be unable to acquire service in a CSFB mode at the mobile communication device's current location.

The general purpose processor 206 and the memory 214 may each be coupled to at least one baseband modem processor 216. Each SIM and/or RAT in the mobile communication device 200 (e.g., SIM-1 204a and SIM-2 204b) may be associated with a baseband-RF resource chain. The baseband-RF resource chain may include the baseband modem processor 216, which may perform baseband/modem functions for communicating with/controlling a RAT, and may include one or more amplifiers and radios, referred to generally herein as RF resources (e.g., an RF resource 218a and an RF resource 218b). In some embodiments, baseband-RF resource chains may share the baseband modem processor 216 (i.e., a single device that performs baseband/modem functions for all RATs of the wireless device). In other embodiments, each baseband-RF resource chain may include physically or logically separate baseband processors (e.g., BB1, BB2).

The RF resources 218a, 218b may each be transceivers associated with and/or used by one or more RATs and may perform transmit/receive functions for the wireless device on behalf of their respective RATs. For example, the RF resource 218a may support an LTE RAT and a first GSM RAT, and the RF resource 218b may support the first GSM RAT and a second GSM RAT. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general purpose processor 206, the memory 214, the baseband processor(s) 216, and the RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the mobile communication device 200 to enable communication between them, as is known in the art.

Functioning together, the two SIMs 204a, 204b, the baseband processor BB1, BB2, the RF resources 218a, 218b, and the wireless antennas 220a, 220b may constitute two or more RATs. For example, a SIM, baseband processor, and RF resource may be configured to support two different RATs. More RATs may be supported on the mobile communication device 200 by adding more SIM cards, SIM interfaces, RF resources, and/or antennae for connecting to additional mobile networks.

The mobile communication device 200 may include a circuit-switch-fallback (CSFB) manager 230 configured to acquire service via an LTE RAT in either a CSFB mode (first mode) or an SGLTE mode (second mode), such as based on whether a network currently available to the LTE RAT is capable of supporting CSFB operations. The CSFB manager 230 may be implemented as a software module implemented on the general purpose processor 206 or the baseband modem processor 216, as a separate hardware component, or as a combination of hardware and software.

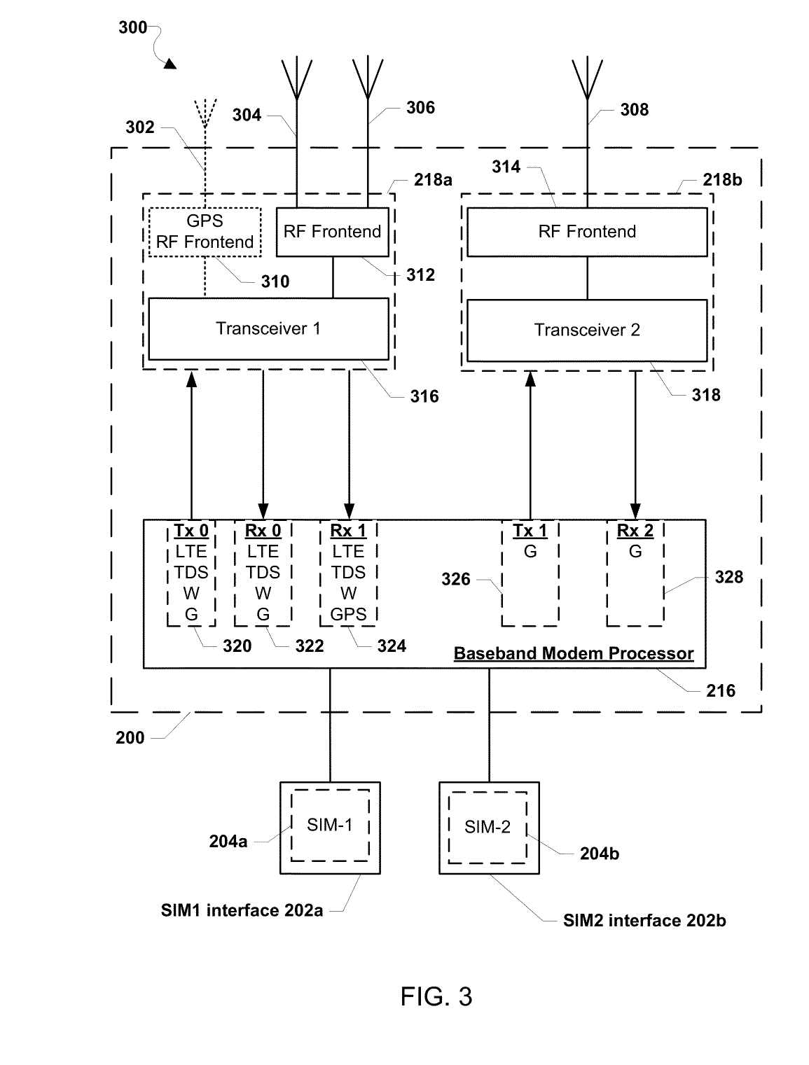

FIG. 3 illustrates a block diagram 300 of transmit and receive components in separate RF resources on an SGLTE+GSM communication device (e.g., the mobile communication device 200 of FIG. 2). With reference to FIGS. 1-3 and as described (see FIG. 2), the baseband modem processor 216 may support the SIMs 204a, 204b via the SIM interfaces 202a, 202b. In some embodiments, the SIM-1 204a may be a “multi-mode” SIM that is capable of utilizing multiple RATs to receive service, such an LTE RAT, a TD-SCDMA or “TDS” RAT, a WCDMA or “W” RAT, and a GSM or “G” RAT. In such embodiments, the SIM-2 204b may be capable of utilizing a GSM RAT to receive service from a GSM network.

The baseband modem processor 216 may manage various communications for the SIMs 204a, 204b related to one or more RATs, and the baseband modem processor 216 may send such communications to and receive such communications from the RF resources 218a, 218b. The baseband modem processor 216 may include various logic circuits 320-328 associated with one or more RATs that may be responsible for sending or receiving information/data to the RF resource 218a, 218b for the SIMs 204a, 204b via one or more RATs.

For example, a logic circuit 320 (labeled in FIG. 3 as “Tx 0”) may send signals, information, and/or data associated with an LTE RAT, a TDS RAT, a WCDMA (“W”) RAT, and/or a GSM (“G”) RAT to the RF resource 218a for transmission via a wireless antenna 304 and/or a wireless antenna 306. Similarly, the logic circuit 322 (labeled in FIG. 3 as “Rx 0”) may receive signals, information, and/or data associated with these RATs from the RF resource 218a, and the logic circuit 324 (labeled in FIG. 3 as “Rx 1”) may receive information related to the LTE RAT, the TDS RAT, and the WCDMA RAT from the RF resource 218a. In some embodiments, the logic circuit 324 may also receive global-positioning-system (GPS) information/coordinates received on a GPS receiver antenna 302 and sent to the logic circuit 324 from a GPS RF frontend 310 in the RF resource 218a. Further, the logic circuit 326 (labeled in FIG. 3 as “Tx 1”) and the logic circuit 328 (labeled in FIG. 3 as “Rx 2”) may be configured, respectively, to send to the RF resource 218b and receive from the RF resource 218b information related to the GSM RAT.

The RF resource 218a may include a transceiver 316 and an RF frontend 312 that, collectively, may be configured to send and receive communications related to the LTE, TDS, WCDMA, and GSM RATs (e.g., from and/or to those RATs' respective networks) via the wireless antenna 304 and/or the wireless antenna 306. The transceiver 316 and/or the RF frontend 312 may serve as a transmitter by, among other things, formatting, modulating, encoding, and interleaving data to be transmitted via the wireless antenna 304 and/or the wireless antenna 306. The transceiver 316 and/or the RF frontend 312 may also serve as a receiver by, among other things, receiving modulated signals from the wireless antennae 304, 306, conditioning the received modulated signal, digitizing the conditioned signal, demodulating the digitized signal, and de-interleaving and decoding the demodulated signal to obtain the original, decoded data. The RF resource 218b may include a transceiver 318 and an RF frontend 314 that may be similarly configured to receive and transmit data/information via a wireless antenna 308 on behalf of a GSM RAT.

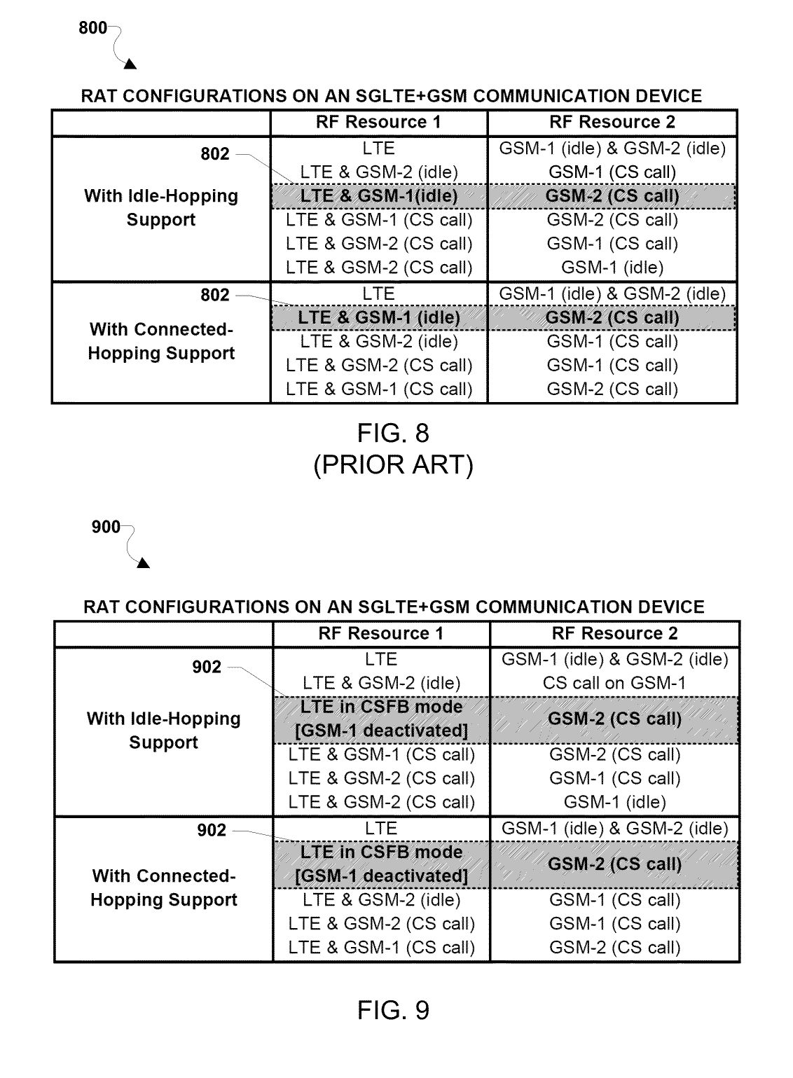

In some embodiments, the baseband modem processor 216 may configure the LTE RAT associated with the SIM-1 204a to operate in an SGLTE mode. In the SGLTE mode, the LTE RAT may be used to receive PS data services, and a first GSM RAT also associated with the SIM-1 204a may be configured to receive CS voice services. For example, the LTE RAT may receive exclusive access to the RF resource 218a to achieve a high PS data throughput, and the first GSM RAT may share access to the RF resource 218b with a second GSM RAT associated with the SIM-2 204b. In other examples (e.g., as described with reference to FIGS. 8-9), the LTE RAT may share access to the RF resource 218a with one of the first GSM RAT and the second GSM RAT, depending on the current operations of the GSM RATs.

In some embodiments, the baseband modem processor 216 may configure the LTE RAT to acquire services in a CSFB mode in the event that a network available to the LTE RAT supports CSFB operations. In the CSFB mode, the LTE RAT may exclusively utilize the RF resource 218a to acquire PS data services from an LTE network and CS paging messages from a CS network. In some embodiments, the processor may simultaneously provide a second GSM RAT associated with the SIM-2 204b with access to the RF resource 218b while the LTE RAT is operating in a CSFB mode on the RF resource 218a to facilitate voice communications with a GSM mobile network.

As described, embodiment mobile communication devices may achieve some benefits by acquiring services with an LTE RAT configured to operate in a CSFB mode, such as a decreased power usage in comparison to the LTE RAT's operating in an SGLTE mode. However, due to the lack of support or partial support for CSFB operations in LTE networks, these benefits may be unavailable based on the current location of the mobile communication device.

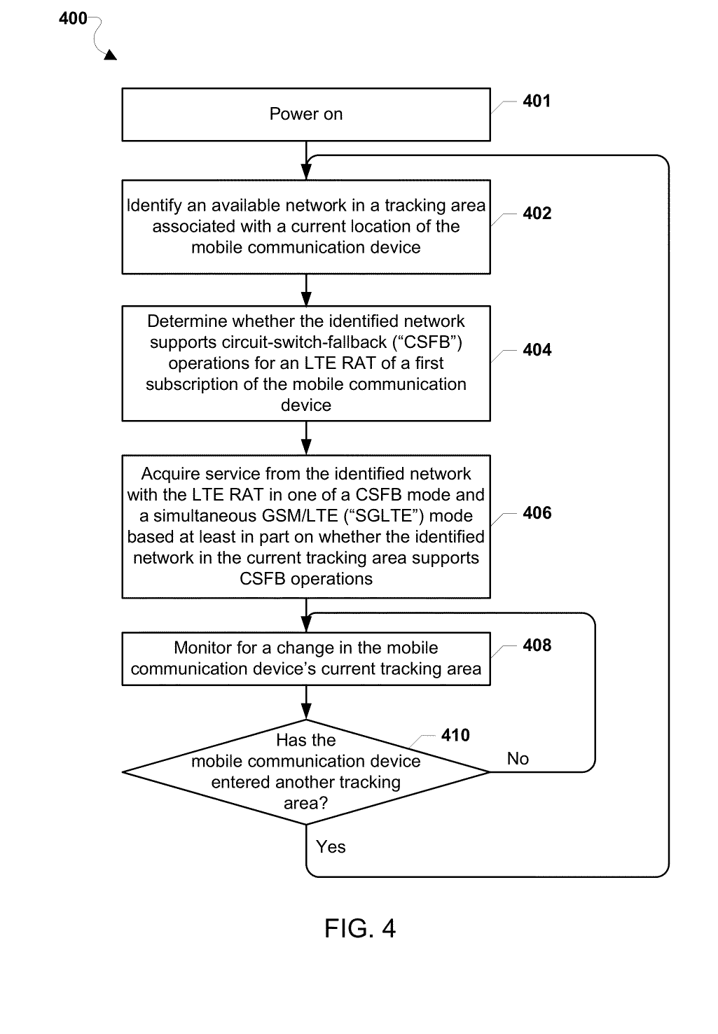

FIG. 4 illustrates a method 400 for acquiring service with an LTE RAT in either a CSFB mode or an SGLTE mode based, at least in part, on whether a network currently available to the LTE RAT supports CSFB operations according to some embodiments. The method 400 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3). With reference to FIGS. 1-4, the device processor may begin performing the operations of the method 400 in response to the mobile communication device's powering on in block 401.

In block 402, the device processor may identify an available network in a tracking area associated with a current location of the mobile communication device. A tracking area is a relatively small group of base stations/cells in a geographical area that are part of an LTE mobile network. As described, CSFB support may be partially implemented in an LTE network and may vary based on the mobile communication device's current location/tracking area. For example, a network available to an LTE RAT in a first geographical location/tracking area may support CSFB operations, whereas a network available to the LTE RAT in a second geographic location/tracking area may not support (or may not yet support) CSFB operations.

In block 404, the device processor may determine whether the network identified in block 402 supports CSFB operations for an LTE RAT of a first subscription of the mobile communication device. In some embodiments of the operations performed in block 404, the device processor may attempt CSFB registration with the identified network, such as by requesting that the identified network enable the LTE RAT to receive PS data services while receiving CS paging messages, and the device processor may receive a signal from the identified network indicating whether the CSFB registration was successful (i.e., whether the identified network supports CSFB operations).

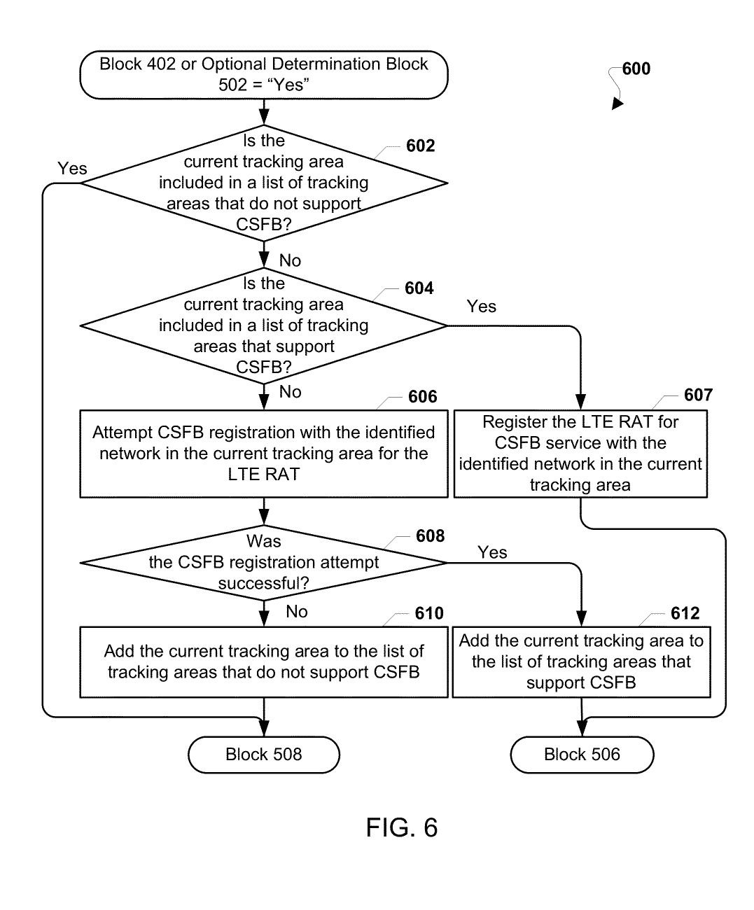

In some embodiments, the device processor may determine whether an available/identified network supports CSFB operations in each new geographical location/tracking area visited. In some embodiments, because tracking areas are discrete geographical areas (i.e., one tracking area does not overlap with another tracking area), the device processor may keep track of the networks that support CSFB operations in different geographic locations by maintaining one or more lists of tracking areas that include networks that support or do not support CSFB operations. Thus, in some embodiments of the operations performed in block 404 (see, e.g., FIG. 6), the device processor may determine whether the identified network supports CSFB operations prior to attempting to register for CSFB service with the identified network by referencing one or more lists of previously visited tracking areas that are associated with networks that do or do not support CSFB operations. In such embodiments, the device processor may quickly determine whether the current tracking area supports (or does not support) CSFB operations without needing to expend the time and resources to attempt a potentially failed CSFB registration.

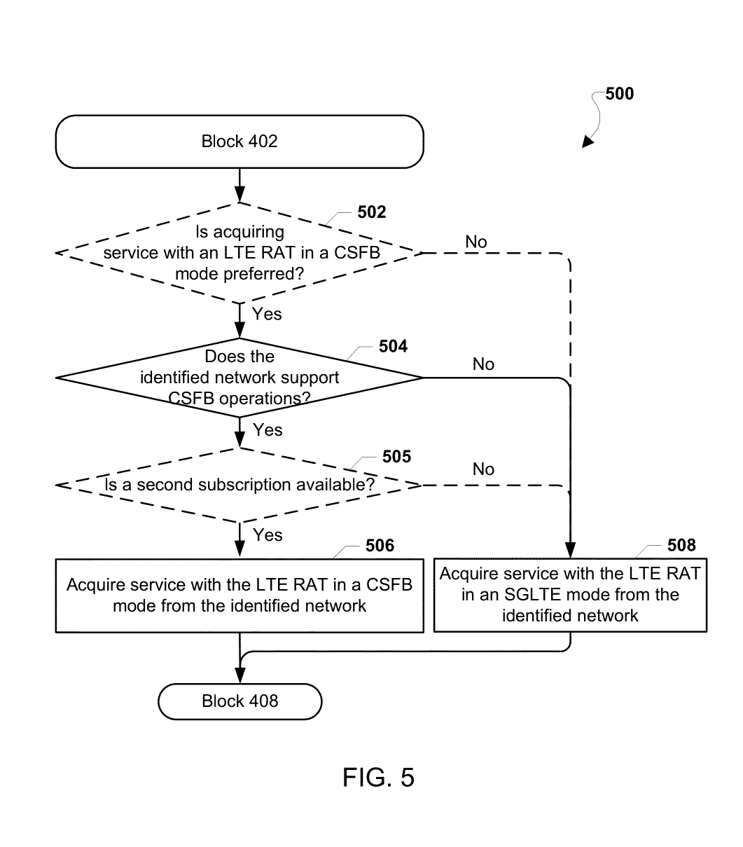

Based at least in part on whether the identified network in the current tracking area supports CSFB operations as determined in block 404, the device processor may acquire service from the identified network with the LTE RAT in either a CSFB mode or an SGLTE mode in block 406. In some embodiments, the device processor may begin acquiring service from the identified network with the LTE RAT in a CSFB mode in response to receiving a message/signal from the identified network indicating that the CSFB registration was successful or may begin acquiring service from the identified network with the LTE RAT in an SGLTE mode in response to receiving an indication that the CSFB registration failed. In some embodiments (see FIG. 5), the device processor may not attempt to acquire service with the LTE RAT in a CSFB mode in response to determining that operating in the CSFB mode is not preferred, for example, because the relatively higher performance of receiving services with the LTE RAT in an SGLTE mode is preferred.

In some embodiments, the device processor may configure the LTE RAT to operate in a CSFB mode by receiving PS data services and CS paging messages on behalf of the first subscription on a first RF resource (e.g., the RF resource 218a) when the identified network supports CSFB operations. In such embodiments, because the LTE RAT is receiving both PS data services and CS paging messages, the device processor may suspend or deactivate a first GSM RAT associated with the first subscription, and the device processor may enable a second GSM RAT to continue receiving CS voice services and PS data services on behalf of a second subscription on a second RF resource (e.g., the RF resource 218b).

In some embodiments, when the identified network does not support CSFB operations the device processor may configure the LTE RAT to operate in an SGLTE mode by receiving PS data services for the first subscription on the first RF resource while the first GSM RAT receives CS voice services for the first subscription on the second RF resource and the second GSM RAT receives CS voice services and PS data services for the second subscription on the second RF resource.

In block 408, the device processor may monitor various data sources for a change in the mobile communication device's current tracking area. For example, the device processor may recognize that the mobile communication device has moved to a different tracking area or location by monitoring for a change in a tracking area code (TAC) that identifies a tracking area within a particular network, a public land mobile network (PLMN) ID, and/or a tracking area identity or “TAI,” which may represent a combination of the TAC and the PLMN ID. Thus, in some embodiments of the operations performed in block 408, the device processor may continually check the TAC, PLMN ID, and/or TAI associated with the tracking area in the mobile communication device's current location to determine whether one or more of the TAC, PLMN ID, and TAI have changed to recognize when the mobile communication device enters a new tracking area.

In determination block 410, the device processor may determine whether the mobile communication devices has entered another tracking area, and may continue monitoring for a change in tracking areas in block 408 until the mobile communication device enters another/different tracking area (i.e., while determination block 410=“No”).

Because networks in a different/new tracking area may provide different CSFB support, in response to determining that the mobile communication device has entered another tracking area (i.e., determination block 410=“Yes”), the device processor may repeat the operations above by again identifying an available network in the new tracking area of the mobile communication device in block 402.

FIG. 5 illustrates a method 500 for acquiring service with the LTE RAT in either a CSFB mode or an SGLTE mode according to some embodiments. The method 500 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3). The operations of the method 500 implement some embodiments of the operations of the method 400 described with reference to FIG. 4. Thus, with reference to FIGS. 1-5, the device processor may begin performing the operations of the method 500 in response to identifying an available network in a tracking area associated with the current location of the mobile communication device in block 402 of the method 400.

In optional determination block 502, the device processor may determine whether acquiring service with an LTE RAT in a CSFB mode is preferred. In other words, the device processor may determine whether to attempt to acquire service with the LTE RAT in a CSFB mode instead of an SGLTE mode. In some embodiments, the device processor may make the determination in optional determination block 502 based on a user input specifying whether a CSFB mode is preferred. For instance, the device processor may determine whether a flag, variable, parameter, etc. indicating a preference for the LTE RAT to operate in the CSFB mode has been set on the mobile communication device (e.g., by a user via a user input). In an example, a user or an original equipment manufacturer (OEM) may select/set the CSFB mode as the preferred mode to configure the mobile communication device to enjoy the potential power savings of operating in the CSFB mode when possible (e.g., as opposed to operating in an SGLTE mode). In contrast, the device processor may receive a user input indicating that operating in an CSFB mode is not preferred or that operating in an SGLTE mode is preferred, which may indicate that the user/OEM has a preference for the higher performance typically associated with acquiring service with the LTE RAT in an SGLTE mode in some circumstances.

In some embodiments of the operations performed in optional determination block 502, the device processor may determine whether receiving PS data services in a CSFB mode is preferred based on the currently available resources of the mobile communication device. For example, in response to determining that mobile communication device's battery is low, the device processor may determine that acquiring services with the LTE RAT in a CSFB mode is preferred due to the comparative low power consumption requirements of operating in the CSFB mode. In another example, the device processor may determine the CSFB mode is not preferred when the mobile communication device does not have a low battery and/or in anticipation of requiring a high data throughput, such as when sending/receiving a comparatively large amount of data via the LTE RAT (e.g., streaming high-resolution video).

In response to determining that acquiring service with the LTE RAT in a CSFB mode is not preferred (i.e., optional determination block 502=“No”), the device processor may acquire service with the LTE RAT in an SGLTE mode from the network identified in block 402 of the method 400, in block 508. In such embodiments, the device processor on the mobile communication device may configure the LTE RAT to receive exclusive access to the first RF resource and may configure the first GSM RAT and the second GSM RAT to share access to the second RF resource (see, e.g., FIG. 3).

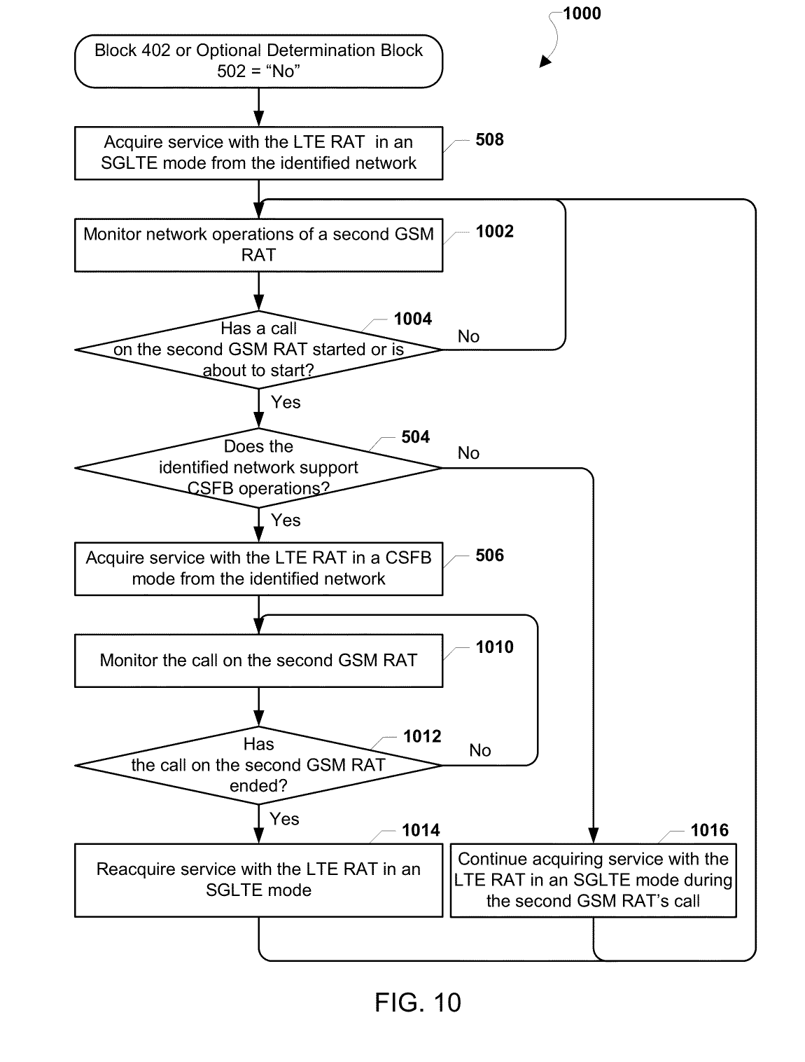

In some embodiments (see FIG. 10), in response to acquiring service with the LTE RAT in an SGLTE mode in block 508, the device processor may begin monitoring the operations of the second GSM RAT to detect when the second GSM RAT initiates a voice call on the second RF chain. Because the first GSM RAT may be temporarily moved to the first RF resource while the second GSM RAT handles the voice call, the LTE RAT of the first RF resource may periodically have to compete with the first GSM RAT for access to the first RF resource, reducing the overall throughput and performance of the LTE RAT during the second GSM RAT's voice call. To avoid this drop in performance, the device processor may temporarily switch the LTE RAT to a CSFB mode during the duration of the second GSM RAT's voice call when the LTE RAT's network supports CSFB operations.

In response to determining that acquiring service with the LTE RAT in a CSFB mode is preferred (i.e., optional determination block 502=“Yes”), the device processor may determine whether the identified network supports CSFB operations in determination block 504. As described (see, e.g., FIG. 4), the device processor may attempt a CSFB registration with the identified network and, based on the result of the registration attempt, may determine that the identified network does not support CSFB registration (i.e., a failed registration) or does support CSFB registration (i.e., a successful registration).

In response to determining that the identified network does not support CSFB operations (i.e., determination block 504=“No”), the device processor may acquire service with the LTE RAT in an SGLTE mode in block 508, as described. In response to determining that the identified network does support CSFB operations (i.e., determination block 504=“Yes”), the device processor may optionally determine whether a second subscription is available, in optional determination block 505. In some embodiments, a second subscription may be unavailable in various situations, such as when the mobile communication device does not include a second SIM card (e.g., the second SIM card has been temporarily removed) or when a user of the mobile communication device or a modem activity has disabled the second subscription. In such embodiments, in response to determining that the second subscription is unavailable (i.e., optional determination block 505=“No”), the device processor may acquire service with the LTE RAT in an SGLTE mode from the identified network in block 508, as described.

In response to determining that the second subscription is available (i.e., optional determination block 505=“Yes”), the device processor may acquire service with the LTE RAT in a CSFB mode from the identified network in block 506. In other words, the device processor may configure the LTE RAT to acquire both PS data services and CS paging messages from the identified network.

In some embodiments (not shown), the device processor may disable/deactivate the first GSM RAT while the LTE RAT is operating in the CSFB mode because the LTE RAT is handling reception of CS paging messages. In such embodiments, the device processor may reactivate/resume the first GSM RAT's operations in response to receiving a CS paging message via the LTE RAT that signals the beginning of a CS voice call. In that event, the first GSM RAT may handle the CS voice call, and the LTE RAT may operate in an SGLTE mode until the call on the first GSM RAT ends, at which point the LTE RAT may resume operating in a CSFB mode.

After acquiring service with the LTE RAT in the CSFB mode in block 506 or acquiring service with the LTE RAT in an SGLTE mode in block 508, the device processor may continue performing the operations in block 408 of the method 400 by monitoring for a change in tracking areas.

FIG. 6 illustrates a method 600 for determining whether a network in a tracking area in the mobile communication device's current location supports CSFB operations according to some embodiments. The method 600 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3). The operations of the method 600 implement some embodiments of the operations of the method 400 described with reference to FIG. 4 and/or the method 500 described with reference to FIG. 5. Thus, with reference to FIGS. 1-6, the device processor may begin performing the operations of the method 600 in response to identifying an available network in a tracking area associated with the current location of the mobile communication device in block 402 of the method 400. In some embodiments, the device processor may begin performing the operations of the method 600 in response to determining that acquiring service with the RAT in a CSFB mode is preferred (i.e., optional determination block 502=“Yes”).

In some embodiments, the device processor may keep track of networks that support CSFB operations in tracking areas that the mobile communication device has previously visited by maintaining a first list of tracking areas that have been previously associated with networks that do not support CSFB operations and a second list of tracking areas that have been previously associated with networks that support CSFB. By keeping track of the tracking areas that support and do not support CSFB registration, the device processor may efficiently determine whether acquiring services with the LTE RAT in a CSFB mode is possible in a current tracking area when the mobile communication device has previously visited that tracking area.

In determination block 602, the device processor may determine whether the current tracking area is included in a list of tracking areas that do not support CSFB operations. As described, the list of tracking areas that do not support CSFB operations may include tracking areas that the mobile communication device has previously visited, and the device processor may update this list for each visited tracking area that does not support CSFB operations. In some embodiments, the mobile communication device may receive a pre-populated list of tracking areas that do not support CSFB. For example, the device processor may receive one or more user inputs specifying the TAC, PLMN-ID, and/or TAI that correspond with networks that do not support CSFB operations. The device processor may also (or alternatively) receive this information from a variety of other sources, such as an original equipment manufacturer, a mobile (e.g., LTE) network, etc.

In response to determining that the current tracking area is included in a list of tracking areas that do not support CSFB operations (i.e., determination block 602=“Yes”), the device processor may continue performing operations in block 508 of the method 500 by acquiring service with the LTE RAT in an SGLTE mode. In other words, because the device processor may use the list of tracking areas that do not support CSFB operations to determine that the current tracking area does not support CSFB operations, the device processor may not attempt CSFB registration with the identified network in the current tracking area. As a result, the device processor may save power and processing resources by avoiding a CSFB registration attempt that is anticipated to fail.

In response to determining that the current tracking area is not included in a list of tracking areas that do not support CSFB operations (i.e., determination block 602=“No”), the device processor may determine whether the current tracking area is included in a list of tracking areas that do support CSFB operations, in determination block 604. In some embodiments, the device processor may have included entries in the list of tracking areas that support CSFB operations in a manner similar to the operations described with reference to the list of tracking areas that do not support CSFB operations. For example, the device processor may have included entries for each previously visited tracking area that includes a network determined to support CSFB operations after a successful CSFB registration attempt.

In response to determining that the current tracking area is included in a list of tracking areas that support CSFB operations (i.e., determination block 604=“Yes”), the device processor may register the LTE RAT for CSFB service with the identified network in the current tracking area in block 607. Specifically, because the current tracking area is included in the list of tracking areas that support CSFB operations, the device processor may determine that the identified network supports CSFB operations before attempting CSFB registration. As a result, the device processor may have a high likelihood of successfully registering for CSFB services with the identified network for the LTE RAT, for example, based on previously successful CSFB registrations of the identified network in the current tracking area.

In response to determining that the current tracking area is not included in a list of tracking areas that supports CSFB operations (i.e., determination block 604=“No”), the device processor may attempt CSFB registration for the LTE RAT with the identified network in the current tracking area in block 606. In other words, in the event that the current tracking area is not included in either of the above lists, the device processor may be unable to determine whether the current tracking area supports CSFB operations without attempting to register the LTE RAT to receive CSFB service. For example, the device processor may have not previously attempted a CSFB registration with the identified network in the current tracking area because the mobile communication device may have entered the current tracking area for the first time.

In determination block 608, the device processor may determine whether the CSFB registration attempted in block 606 was successful, such as in response to receiving an indication/signal from the identified network. In response to determining that the CSFB registration attempt was not successful (i.e., determination block 608=“No”), the device processor may add the current tracking area to the list of tracking areas that do not support CSFB operations in block 610. In response to determining that the CSFB registration attempt was successful (i.e., determination block 608=“Yes”), the device processor may add the current tracking area to the list of tracking areas that support CSFB operations in block 612. By adding the current tracking area to either the list of tracking areas that support CSFB operations or the list of tracking areas that do not support CSFB operations, the device processor may quickly determine whether the current tracking area supports CSFB operations in the event that the mobile communication device leaves the area and revisits the current tracking area at a later time. The device processor may continue performing operations in block 508 of the method 500 by acquiring service with LTE RAT in an SGLTE mode as described.

After registering the LTE RAT for CSFB service with the identified network in block 607 or adding the current tracking area to the list of tracking areas that support CSFB operations in block 612, the device processor may continue performing operations in block 506 of the method 500 by acquiring service with LTE RAT in a CSFB mode from the identified network as described.

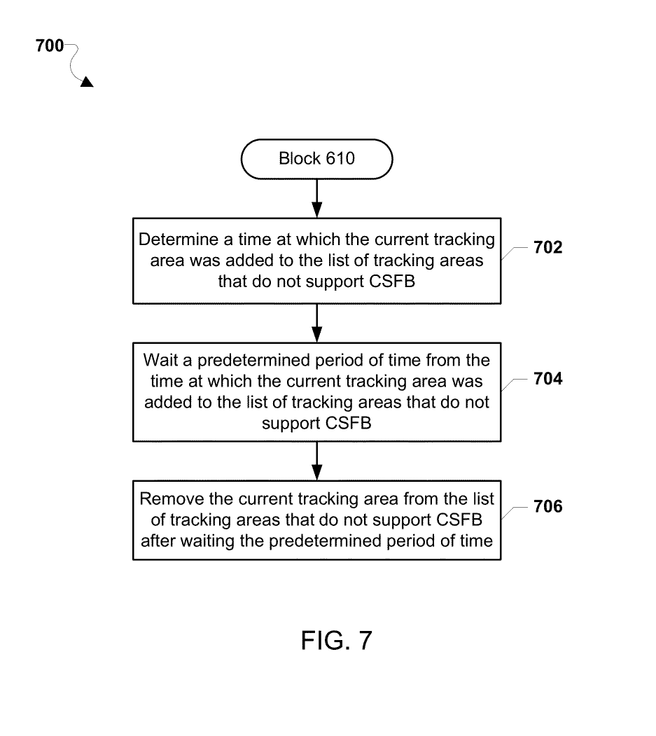

FIG. 7 illustrates a method 700 for periodically updating the list of tracking areas that do not support CSFB according to some embodiments. The method 700 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3). The operations of the method 700 implement some embodiments of the operations of the method 600 described with reference to FIG. 6.

As described, CSFB support may not be available (or may only be partially available) on some networks. However, as the prevalence and availability of LTE communications continues to expand, networks are continually being upgraded to better facilitate LTE communications and, as a result, may eventually be upgraded to add support for CSFB operations. To account for the likelihood that a network previously determined not to support CSFB operations will, at some later point, be upgraded to support CSFB operations, the device processor may occasionally remove tracking-area entries from the list of tracking areas that do not support CSFB operations. In other words, the device processor may, in essence, reclassify those removed tracking areas as having been “unvisited,” and the device processor may make another determination regarding whether available networks in those tracking areas support CSFB in the event that the mobile communication device revisits those tracking areas at a later time.

Thus, with reference to FIGS. 1-7, the device processor may begin performing the operations of the method 700 in response to adding the current tracking area to the list of tracking areas that do not support CSFB operations in block 610 of the method 600.

In block 702, the device processor may determine a time at which the current tracking area was added to the list of tracking areas that do not support CSFB operations, such as based on the time observed on the mobile communication device at or near the time the device processor added the current tracking area to the list of non-supporting tracking areas in block 610 of the method 600.

In block 704, the device processor may wait a predetermined period of time from the time at which the current tracking area was added to the list of tracking areas that do not support CSFB operations. In some embodiments, the predetermined period of time may reflect an estimated amount of time required to upgrade the current tracking area to support CSFB operations. The predetermined period of time may be received as a user input and/or from a network in the current tracking area. For example, the device processor may receive the predetermined period of time from the identified network in the current tracking area based on a time that upgrading that network to support CSFB operations is expected to finish.

In some embodiments, the predetermined period of time may correspond to days, weeks, or months. As such, the device processor may store the time associated with the current tracking area in block 702 in non-volatile memory (e.g., the memory 214) to enable the device processor to wait the necessary amount of time in block 704, even in the event that the mobile communication device is temporarily powered down.

In block 706, the device processor may remove the current tracking area from the list of tracking areas that do not support CSFB operations after waiting the predetermined period of time. As a result, in the event that the mobile communication device returns to the current tracking area after moving to another tracking area, the device processor may perform operations similar to those described with reference to the method 600 (see FIG. 6) in order to reclassify the current tracking area. In other words, the device processor may again determine whether an available network in the current tracking area supports CSFB operations by attempting CSFB registration with that network, as described.

In some embodiments (not shown), the device processor may perform operations similar to those described with reference to the method 700 in order to update the list of tracking areas that support CSFB operations to reflect changes (e.g., downgrades or improvements) to previously visited tracking areas. For example, after adding a tracking area to the list of tracking areas that support CSFB operations (see block 612 of the method 600), the device processor may determine a time at which that tracking area was added to the list, wait a predetermined period of time from the time at which the tracking area was added to the list of tracking areas that support CSFB operations, and remove that tracking area from the list of tracking areas that support CSFB operations after waiting the predetermined period of time. As a result, the device processor may determine whether that tracking area still supports CSFB operations (and/or to what extent that tracking area supports CSFB operations) the next time the mobile communication device enters that tracking area by again attempting CSFB registration with that network.

FIG. 8 is a table 800 illustrating various RAT configurations on a conventional SGLTE+GSM communication device that supports a first subscription and a second subscription. In such communication devices, the first subscription utilizes an LTE RAT to received PS data services and a first GSM RAT (labeled in FIGS. 8-9 as “GSM-1”) to receive CS voice operations, and the second subscription only utilizes a second GSM RAT (labeled in FIGS. 8-9 as “GSM-2”) to receive both PS data services and CS voice services.

As illustrated in the table 800, the LTE RAT, the first GSM RAT, and the second GSM RAT utilize the first and second RF resources (labeled in FIGS. 8-9 as “RF Resource 1” and “RF Resource 2,” respectively) in various combinations depending on their respective operational statuses. For example, the LTE RAT receives exclusive access to the first RF resource when the first and second GSM RATs are performing idle-standby-mode operations on the second RF resource. As described, in this particular RAT configuration, the LTE may experience comparatively high performance and data throughput.

The table 800 also illustrates RAT configurations of the conventional SGLTE+GSM communication device based on whether the communication device supports idle-hopping or connected-hopping support. Typically, supporting idle hopping enables the SGLTE+GSM communication device to move the idle-standby-mode operations of either the first or second GSM RAT to the first RF resource in response to detecting that a CS voice call has been initiated by the other GSM RAT. For example, when the first GSM RAT initiates a CS voice call on the second RF resource, the idle-standby-mode operations of the second GSM RAT are moved to the first RF resource, which is also utilized by the LTE RAT. Similarly, if the conventional SGLTE+GSM communication device supports connected hopping, the device processor is able to move the CS-voice-call operations of the first and second GSM RATs to the first or second RF resources.

As described, the LTE RAT may experience a high data throughput and performance when the LTE RAT has exclusive access to the first RF resource. However, in some RAT configurations in which the LTE RAT shares the first RF resource with the first GSM RAT (i.e., a RAT configuration 802), the LTE RAT periodically loses access to the first RF resource to enable the first GSM RAT to perform various idle-mode operations. As a result, while in the RAT configuration 802, the first subscription receives degraded PS data services from the LTE RAT in order to receive CS idle-standby-mode services (e.g., paging messages, power monitoring operations, etc.) from the first GSM RAT.

FIG. 9 is a table 900 illustrating various RAT configurations on an SGLTE+GSM communication device (e.g., the mobile communication device 200 of FIG. 2-3) according to various embodiments. With reference to FIGS. 1-9, a device processor of the SGLTE+GSM communication device (e.g., the general purpose processor 206, the baseband modem processor 216, the CSFB manager 230, a separate controller, and/or the like) may configure the LTE RAT to switch from an SGLTE mode to a CSFB mode to improve the performance of the LTE RAT.

Specifically, the device processor may monitor for the second GSM RAT to initiate a CS voice call on the second RF resource while the first GSM RAT is performing CS idle-standby-mode operations. As described, conventional SGLTE+GSM communication devices configure the LTE RAT and the first GSM RAT to share the first RF resource under these circumstances (see, e.g., the RAT configuration 802), resulting in degraded performance on the LTE RAT.

Thus, in some embodiments, the device processor may temporarily configure the LTE RAT to operate in a CSFB mode and may temporarily suspend/deactivate the first GSM RAT while the second GSM RAT is on an active CS voice call, as illustrated in a RAT configuration 902. In such embodiments, the device processor may configure the LTE RAT to resume SGLTE-mode operations in response to a change in the RATs' configurations (i.e., changing from the RAT configuration 902 to another RAT configuration), such as when the second GSM RAT ends its voice call or when the first GSM RAT initiates another CS voice call.

FIG. 10 illustrates a method 1000 for temporarily switching an LTE RAT's operations from an SGLTE mode to a CSFB mode while a second GSM RAT is on a voice call according to some embodiments. The method 1000 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3).

Acquiring service via the LTE RAT in SGLTE mode on an SGLTE+GSM communication device may allow for comparatively high data throughput and better performance than operating in a CSFB mode because the LTE RAT is able to exclusively use a first RF resource to receive PS data services, while a first GSM RAT is able to receive CS voice services on the second RF resource. However, in the event that the second GSM RAT initiates an active call on the second RF resource, the first GSM RAT typically may be moved to the first RF resource and may compete with the LTE RAT for access to the RF chain (see, e.g., the RAT configuration 802 of FIG. 8).

With reference to FIGS. 1-10, to avoid a degradation in the performance and/or throughput of the LTE RAT during the second GSM RAT's CS voice call, the device processor may perform the operations of the method 1000. In some embodiments, the operations of the method 1000 implement some embodiments of the operations performed in the method 500 (see FIG. 5). Thus, in such embodiments, the device processor may begin performing the operations of the method 1000 in response to determining that acquiring service with the LTE RAT in a CSFB mode is not preferred (i.e., optional determination block 502=“No”).

In some embodiments, the operations of the method 1000 may implement some embodiments of the operations performed in the method 400 (see FIG. 4). In such embodiments, the device processor may begin performing the operations of the method 1000 in response to identifying an available network in a tracking area associated with the current location of the mobile communication device in block 402 of the method 400.

In block 508, the device processor may acquire service with the LTE RAT in an SGLTE mode from the identified network, such as by performing operations similar to those operations described with reference to block 508 of the method 500. For example, the device processor may register the LTE RAT with the identified network to receive PS data services via the first RF resource, while the first and second GSM RATs perform idle-standby-mode operations on the second RF resource.

In block 1002, the device processor may monitor network operations of the second GSM RAT to determine whether the second GSM RAT is about to initiate or receive a CS voice call, which may cause the LTE RAT to share the first RF resource with the first GSM RAT (see, e.g., the RAT configuration 802).

In determination block 1004, the device processor may determine whether a call on the second GSM RAT has started or is about to start, and may continue monitoring the network operations of the second GSM RAT until the second GSM RAT initiates or is about to initiate a call (i.e., while determination block 1004=“No”). In other words, by determining that the second GSM RAT is not about to start or is not starting a CS voice call, the device processor may continue to enable the LTE RAT to experience a high quality of performance by operating in an SGLTE mode.

In response to determining that a call on the second GSM RAT has started or is about to start (i.e., determination block 1004=“Yes”), the device processor may determine whether the network identified in block 402 of the method 400 supports CSFB operations, in determination block 504, such as by attempting to register the LTE RAT with the identified network for CSFB service as described with reference to determination block 504 of the method 500 (e.g., see FIG. 5).

In response to determining that the identified network does not support CSFB operations (determination block 504=“No”), the device processor may continue acquiring service with the LTE RAT in an SGLTE mode during the second GSM RAT's call in block 1016. In other words, because the identified network does not support CSFB operations, the LTE RAT may be forced to operate in an SGLTE mode. As a result, the LTE RAT may have to share the first RF resource with the first GSM RAT and, thus, may be unable to avoid degraded performance while the second GSM RAT is on the CS voice call.

The device processor may continue performing the above operations in block 1002 of the method 1000 by again monitoring network operations of the second GSM RAT to determine whether another call on the second GSM Rat has started or is about to start (i.e., determination block 1004=“Yes”). In some embodiments (not shown), the device processor may repeat the above operations in response to determining that the call on the second GSM RAT has ended.

In response to determining that the identified network supports CSFB mode (i.e., determination block 504=“Yes”), the device processor may acquire service with the LTE RAT in a CSFB mode from the identified network in block 506. In some embodiments of the operations performed in block 506, the device processor may perform operations similar to those described in block 506 of the method 500 (see FIG. 5). For example, the device processor may attempt CSFB registration with the identified network to enable the LTE RAT to begin receiving CS paging messages.

In block 1010, the device processor may monitor the call on the second GSM RAT for an indication that the call has ended. In determination block 1012, the device processor may determine whether the call on the second GSM RAT has ended, and may continue monitoring the call on the second GSM RAT until the second GSM RAT's call ends (i.e., while determination block 1012=“No”).

In response to determining the call on the second GSM RAT has ended (i.e., determination block 1012=“Yes”), the device processor may re-acquire service with the LTE RAT in an SGLTE mode in block 1014, such as by deregistering the LTE RAT's CSFB services with the identified network, which may cause the identified network to cease sending CS paging messages to the LTE RAT. The device processor may continue by repeating the above operations of the method 1000 in block 1002 by again monitoring network operations of the second GSM RAT to determine whether another call has started (or is about to start) on the second GSM (i.e., determination block 1004=“Yes”).

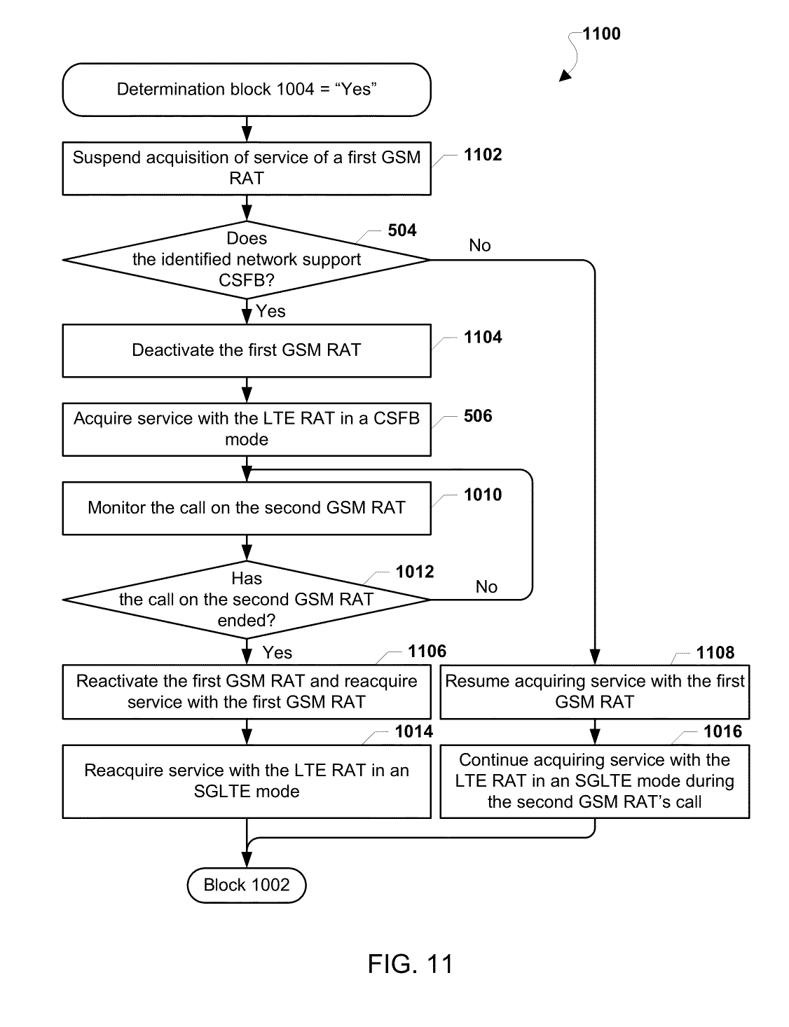

FIG. 11 illustrates a method 1100 for temporarily switching an LTE RAT's operations from an SGLTE mode to a CSFB mode and temporarily deactivating a first GSM RAT while a second GSM RAT is on a voice call according to some embodiments. The method 1100 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3). The operations of the method 1100 implement some embodiments of the operations of the method 1000 as described with reference to FIG. 10. Thus, with reference to FIGS. 1-11, the device processor may begin performing the operations of the method 1100 in response to determining that a call has started or is about to start on the second GSM RAT (i.e., determination block 1004=“Yes”).

In block 1102, the device processor may suspend the operations of the first GSM RAT. In some embodiments, the device processor may initially suspend the operations of the first GSM RAT until the device processor is able to determine in determination block 504 whether it is possible to switch the LTE from operating in an SGLTE mode to operating a CSFB mode. By suspending the first GSM RAT, the device processor may quickly disable the first GSM RAT or resume operations of the first GSM RAT based on whether the identified network supports CSFB operations. In other words, the device processor may avoid prematurely disabling the first GSM RAT in the event that the identified RAT does not support CSFB operations, which may otherwise cause the device processor to waste time and resources to re-enable the first GSM RAT and resume receiving CS voice services with the first GSM RAT.

In determination block 504, the device processor may determine whether the identified network supports CSFB operations, such as by performing operations similar to those operations described with reference to determination block 504 of the methods 500, 1000 (see FIGS. 5 and 10). In response to determining that the identified network does not support CSFB operations (i.e., determination block 1006=“No”), the device processor may resume acquiring service with the first GSM RAT in block 1108. Thus, by suspending (rather than deactivating) the first GSM RAT, the device processor may quickly reacquire CS voice services with the first GSM RAT. The device processor may also continue acquiring service with the LTE RAT in an SGLTE mode during the second GSM RAT's call in block 1016, by performing operations similar to those described in block 1016 of the method 1000 (see FIG. 10).

In response to determining that the identified network does support CSFB operations (i.e., determination block 504=“Yes”), the device processor may deactivate the first GSM RAT in block 1104. In some embodiments, the device processor may send a notification to the first GSM RAT's network requesting the network to cease servicing the first subscription via the first GSM RAT in order to avoid unnecessary transmissions and retransmissions from the first GSM RAT's network.

In some embodiments, the device processor may perform operations in blocks 506 and 1010-1012, such as by performing operations similar to those described with reference to blocks 506 and 1010-1012 of the method 1000 (see FIG. 10). Thus, the device processor may acquire service with the LTE RAT in a CSFB mode in block 506 and monitor the call on the second GSM RAT in block 1010 as long as the call on the second GSM RAT has not ended (i.e., while determination block 1012=“No”).

In response to determining that the call on the second GSM RAT has ended (i.e., determination block 1012=“Yes”), the device processor may reactivate the first GSM RAT and may reacquire service with the first GSM RAT in block 1106. For example, the device processor may reactivate the first GSM RAT and register to receive service via the first GSM RAT via an available GSM network. The device processor may also reacquire service with the LTE RAT in an SGLTE mode in block 1014, such as by performing operations similar to those performed in block 1014 of the method 1000.

In response to reacquiring service with the LTE RAT in an SGLTE mode in block 1014 or in response to continuing to acquire service with the LTE RAT in an SGLTE mode during the second GSM RAT's call in block 1016, the device processor may continue performing in block 1002 of the method 1000 by again monitoring the network operations of the second GSM RAT to determine whether the second GSM RAT has initiated another call.

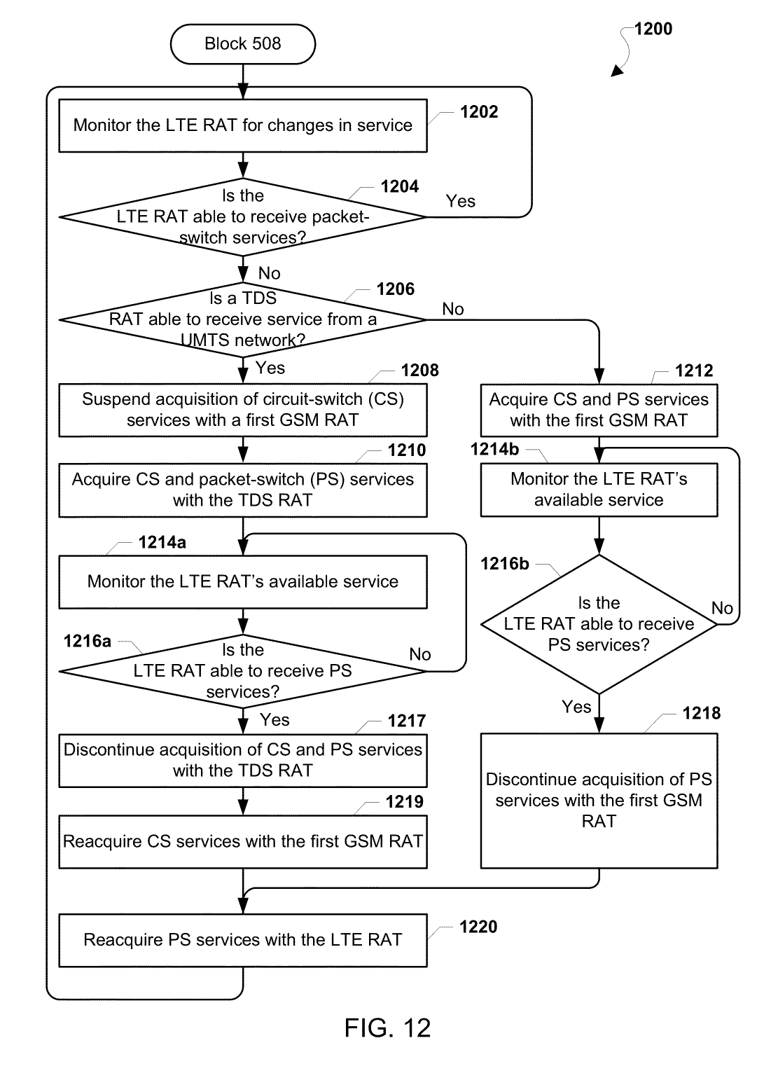

FIG. 12 illustrates a method 1200 for acquiring service with another RAT in response to determining that the LTE RAT is unable to receive service while operating in an SGLTE mode according to some embodiments. The method 1200 may be implemented with a processor (e.g., the general purpose processor 206 of FIG. 2, the baseband modem processor 216, the CSFB manager 230, a separate controller, and/or the like) of a mobile communication device (e.g., the mobile communication device 200 of FIG. 2-3). The operations of the method 1200 implement some embodiments of the operations of the method 500 as described with reference to FIG. 5. Thus, with reference to FIGS. 1-12, the device processor may begin performing the operations of the method 1200 in response to acquiring service with the LTE RAT in an SGLTE mode in block 508 of the method 500.

In block 1202, the device processor may monitor the LTE RAT for changes in service, such as by monitoring decreases in the received signal strength of the LTE RAT's network or monitoring whether the LTE RAT is out of service (e.g., out of the LTE network's service/coverage area). In determination block 1204, the device processor may determine whether the LTE RAT is able to receive packet-switch (PS) data services, and may continue monitoring the LTE RAT for changes in service in block 1202 until the LTE RAT is unable to receive PS data services (i.e., while determination block 1204=“Yes”). In some embodiments of the operations performed in determination block 1204, the device processor may determine that the LTE RAT is unable to receive PS data services when the LTE RAT's received signal strength, quality of service, etc. does not satisfy a minimum threshold.

In response to determining that the LTE RAT is unable to receive PS data services (i.e., determination block 1204=“No”), the device processor may determine whether a TD-SCDMA (“TDS”) RAT is available to receive service from a Universal Mobile Telecommunications System (UMTS) network, in determination block 1206. Specifically, because the LTE RAT is unable to receive PS data services, the device processor may determine whether PS data services may be acquired using the TDS RAT, which may leverage the relatively high data rates available on the UMTS network.

In response to determining that a TDS RAT is able to receive service (i.e., determination block 1206=“Yes”), the device processor may suspend acquisition of circuit-switch (CS) services (e.g., voice services) with the first GSM RAT in block 1208, and may acquire CS services and PS data services with the TDS RAT in block 1210. Specifically, the device processor may suspend the first GSM RAT in favor of the TDS RAT in order to avoid the possibility that the first GSM RAT will compete with the TDS RAT for access to a shared RF resource, which may degrade the performance and data throughput of the TDS RAT.

In block 1214a, the device processor may monitor the LTE RAT's available service. In determination block 1216a, the device processor may determine whether the LTE RAT is again able to receive PS data services, and may continue monitoring the LTE RAT's available service for improvements in block 1214a until the LTE RAT is able to receive PS data services (i.e., while determination block 1216a=“No”). For instance, the device processor may periodically monitor the LTE RAT's received signal strength and/or other indications from the LTE RAT's network.

In response to determining that the LTE RAT is able to receive PS data services (i.e., determination block 1216a=“Yes”), the device processor may discontinue receiving CS and PS data services with the TDS RAT in block 1217. In some embodiments, the device processor may discontinue receiving services with the TDS RAT in block 1217 as part of switching the acquisition of services from the TDS RAT to the LTE RAT and the first GSM RAT. Thus, the device processor may reacquire CS services with the first GSM RAT in block 1219, and the device processor may reacquire PS data services with the LTE RAT in block 1220.

In response to determining that the TDS RAT is unable to receive service (i.e., determination block 1206=“No”), the device processor may acquire CS services and PS data services with the first GSM RAT in block 1212, for example, because the TDS RAT and the LTE RAT are both out of service and/or are out of their respective networks' service area. As such, the first subscription may receive both PS data and CS services via the first GSM RAT.

The device processor may perform the operations in blocks 1214b, 1216b as described with reference to block 1214a, 1214a. Thus, the device processor may monitor the LTE RAT's available services in block 1214b until determining that the LTE RAT is able to receive PS services (i.e., while determination block 1216b=“No”). In response to determining that the LTE RAT is able to receive PS data services (i.e., determination block 1216b=“Yes”), the device processor may discontinue receiving PS data services with the first GSM RAT in block 1218, and the device processor may reacquire PS data services with the LTE RAT in block 1220, as described.

Thus, in some embodiments, by performing the operations in blocks 1217, 1219, 1220 or by performing the operations in blocks 1218 and 1220, the device processor may, in essence, resume receiving services via the LTE RAT in an SGLTE mode, in which the LTE RAT receives PS data services at the same time that the first GSM RAT receives CS services, as described.

The device processor may repeat the above operations in block 1202 of the method 1200 by again monitoring the LTE RAT for changes in coverage.

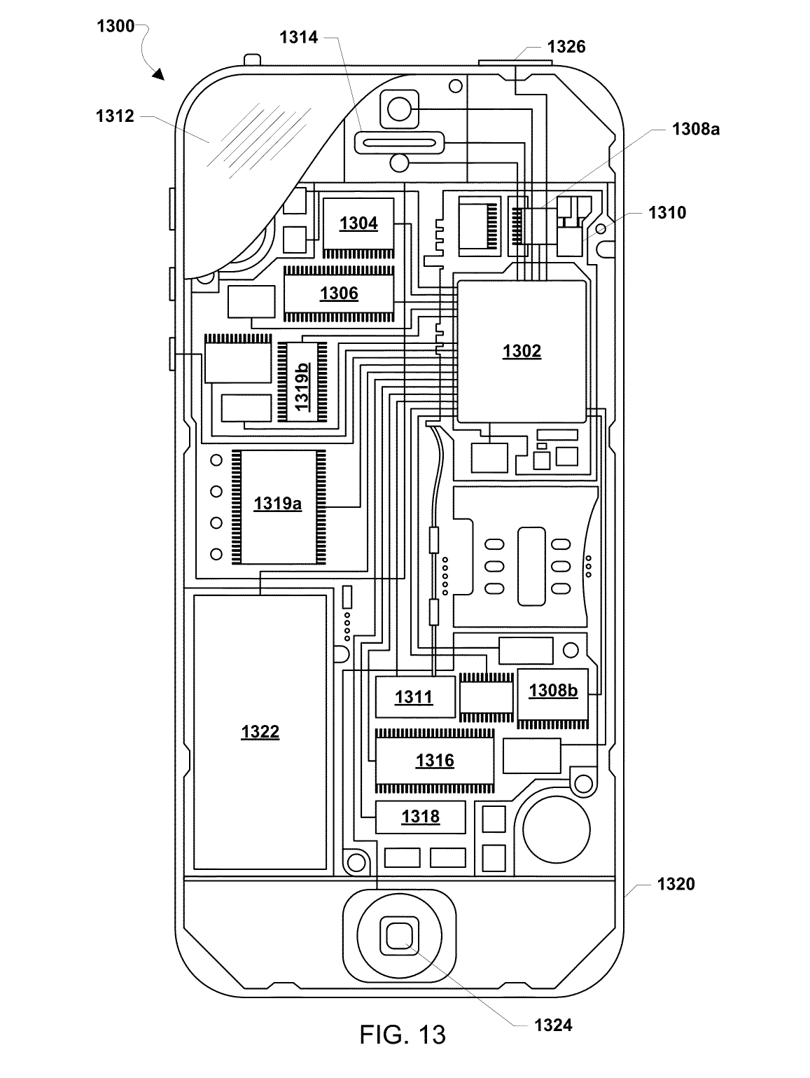

Various embodiments may be implemented in any of a variety of mobile communication devices, an example of which (e.g., a mobile communication device 1300) is illustrated in FIG. 13. According to various embodiments, the mobile communication device 1300 may be similar to the mobile communication devices 110, 120, 200 as described above with reference to FIGS. 1-3. As such, the mobile communication device 1300 may implement the methods 400, 500, 600, 700, 1000, 1100, 1200 of FIGS. 4-7 and 10-12.

With reference to FIGS. 1-13, the mobile communication device 1300 may include a processor 1302 coupled to a touchscreen controller 1304 and an internal memory 1306. The processor 1302 may be one or more multi-core integrated circuits designated for general or specific processing tasks. The internal memory 1306 may be volatile or non-volatile memory, and may also be secure and/or encrypted memory, or unsecure and/or unencrypted memory, or any combination thereof. The touchscreen controller 1304 and the processor 1302 may also be coupled to a touchscreen panel 1312, such as a resistive-sensing touchscreen, capacitive-sensing touchscreen, infrared sensing touchscreen, etc. Additionally, the display of the mobile communication device 1300 need not have touch screen capability.

The mobile communication device 1300 may have one or more radio signal transceivers 1308a, 1308b (e.g., Peanut, Bluetooth, Zigbee, Wi-Fi, RF radio) and one or more antennae 1310, 1311, for sending and receiving communications, coupled to each other and/or to the processor 1302. The transceivers 1308a, 1308b and antennae 1310, 1311 may be used with the above-mentioned circuitry to implement the various wireless transmission protocol stacks and interfaces. The mobile communication device 1300 may include two or more SIM cards (e.g., SIMs 1319a, 1319b) coupled to the transceivers 1308a, 1308b and/or the processor 1302 and configured as described above. The mobile communication device 1300 may include one or more cellular network wireless modem chip(s) 1316 coupled to the processor 1302 and antennae 1310, 1311 that enables communication via two or more cellular networks via two or more radio access technologies.

The mobile communication device 1300 may include a peripheral device connection interface 1318 coupled to the processor 1302. The peripheral device connection interface 1318 may be singularly configured to accept one type of connection, or may be configured to accept various types of physical and communication connections, common or proprietary, such as USB, FireWire, Thunderbolt, or PCIe. The peripheral device connection interface 1318 may also be coupled to a similarly configured peripheral device connection port (not shown).

The mobile communication device 1300 may also include speakers 1314 for providing audio outputs. The mobile communication device 1300 may also include a housing 1320, constructed of a plastic, metal, or a combination of materials, for containing all or some of the components discussed herein. The mobile communication device 1300 may include a power source 1322 coupled to the processor 1302, such as a disposable or rechargeable battery. The rechargeable battery may also be coupled to the peripheral device connection port to receive a charging current from a source external to the mobile communication device 1300. The mobile communication device 1300 may also include a physical button 1324 for receiving user inputs. The mobile communication device 1300 may also include a power button 1326 for turning the mobile communication device 1300 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method implemented by a mobile communication device for acquiring service with a Long Term Evolution (LTE) radio access technology (RAT) associated with a first subscription, comprising:
identifying a network that is available in a first tracking area associated with a current location of the mobile communication device;
determining whether the identified network supports circuit-switch-fallback (CSFB) operations for the LTE RAT; and
acquiring service from the identified network with the LTE RAT in one of a CSFB mode and a simultaneous Global System for Mobile Communications (GSM)/LTE (SGLTE) mode based at least in part on the determination of whether the identified network supports CSFB operations.

2. The method of claim 1, wherein the mobile communication device is a multi-SIM, multi-active communication device that simultaneous supports GSM/LTE plus GSM network connectivity.

3. The method of claim 1, wherein:
the method further comprises determining whether a second subscription is available in response to determining that the identified network supports CSFB operations for the LTE RAT; and
acquiring service from the identified network with the LTE RAT in one of a CSFB mode and an SGLTE mode comprises acquiring service with the LTE RAT in an SGLTE mode from the identified network in response to determining that the second subscription is not available.

4. The method of claim 1, further comprising:
determining whether the mobile communication device has entered a second tracking area;
identifying a network that is available in the second tracking area in response to determining that the mobile communication device has entered the second tracking area;
determining whether the available network in the second tracking area supports CSFB operations for the LTE RAT; and
acquiring service from the available network in the second tracking area with the LTE RAT in one of a CSFB mode and an SGLTE mode based at least in part on the determination of whether the available network in the second tracking area supports CSFB operations.

5. The method of claim 1, wherein acquiring service from the identified network with the LTE RAT in one of a CSFB mode and an SGLTE mode based at least in part on the determination of whether the identified network supports CSFB operations comprises acquiring service from the identified network with the LTE RAT in a CSFB mode in response to determining that the identified network supports CSFB operations for the LTE RAT.

6. The method of claim 1, wherein acquiring service from the identified network with the LTE RAT in one of a CSFB mode and an SGLTE mode based at least in part on the determination of whether the identified network supports CSFB operations comprises acquiring service from the identified network with the LTE RAT in an SGLTE mode in response to determining that the identified network does not support CSFB operations for the LTE RAT.

7. The method of claim 6, further comprising:
determining whether the LTE RAT is able to receive packet-switch services; and
determining whether a Time Division Synchronous Code Division Multiple Access (TD-SCDMA) RAT associated with the first subscription is able to receive service in response to determining that the LTE RAT is unable to receive packet-switch services.

8. The method of claim 7, further comprising:
suspending acquisition of circuit-switch services with a GSM RAT associated with the first subscription; and
acquiring circuit-switch services and packet-switch services with the TD-SCDMA RAT in response to determining that the TD-SCDMA RAT is able to receive service.

9. The method of claim 8, further comprising:
determining whether the LTE RAT is again able to receive packet-switch services; and
performing operations in response to determining that the LTE RAT is again able to receive packet-switch services, the operations comprising:
discontinuing acquisition of circuit-switch services and packet-switch services with the TD-SCDMA RAT;
reacquiring circuit-switch services with the GSM RAT; and
reacquiring packet-switch services with the LTE RAT.

10. The method of claim 7, further comprising acquiring circuit-switch services and packet-switch services with a GSM RAT associated with the first subscription in response to determining that the TD-SCDMA RAT is unable to receive service.

11. The method of claim 10, further comprising:
determining whether the LTE RAT is again able to receive packet-switch services; and
performing operations in response to determining that the LTE RAT is again able to receive packet-switch services, the operations comprising:
discontinuing acquisition of packet-switch services with the GSM RAT; and
reacquiring packet-switch services with the LTE RAT.

12. The method of claim 1, further comprising:
determining whether acquiring service with the LTE RAT in a CSFB mode is preferred,
wherein acquiring service from the identified network with the LTE RAT in one of a CSFB mode and an SGLTE mode comprises acquiring service from the identified network with the LTE RAT in an SGLTE mode in response to at least one of determining that acquiring service with the LTE RAT in a CSFB mode is not preferred and determining that the identified network does not support CSFB operations for the LTE RAT.

13. The method of claim 12, wherein acquiring service from the identified network with the LTE RAT in one of a CSFB mode and an SGLTE mode further comprises acquiring service from the identified network with the LTE RAT in a CSFB mode in response to determining that the identified network supports CSFB operations for the LTE RAT and that acquiring service with the LTE RAT is a CSFB mode is preferred.

14. The method of claim 1, wherein:
determining whether the identified network supports CSFB operations for the LTE RAT comprises determining whether the first tracking area is included in a first list of tracking areas that do not support CSFB operations; and
acquiring service from the identified network with the LTE RAT in one of a CSFB mode and an SGLTE mode comprises acquiring service from the identified network with the LTE RAT in an SGLTE mode in response to determining that the first tracking area is included in the first list of tracking areas.

15. The method of claim 14, wherein:
determining whether the identified network supports CSFB operations for the LTE RAT further comprises determining whether the first tracking area is included in a second list of tracking areas that support CSFB operations; and
acquiring service from the identified network with the LTE RAT in one of a CSFB mode and an SGLTE mode further comprises acquiring service from the identified network with the LTE RAT in a CSFB mode in response to determining that the first tracking area is included in the second list of tracking areas.

16. The method of claim 15, wherein determining whether the identified network supports CSFB operations for the LTE RAT further comprises:
attempting CSFB registration with the identified network for the LTE RAT in response to determining that the first tracking area is not included in the first list of tracking areas and the second list of tracking areas; and
determining whether the CSFB registration attempt was successful.

17. The method of claim 16, wherein acquiring service from the identified network with the LTE RAT in one of a CSFB mode and an SGLTE mode comprises:
adding the first tracking area to the first list of tracking areas and acquiring service from the identified network with the LTE RAT in an SGLTE mode in response to determining that the CSFB registration attempt was unsuccessful; and
adding the first tracking area to the second list of tracking areas and acquiring service from the identified network with the LTE RAT in a CSFB mode in response to determining that the CSFB registration attempt was successful.

18. The method of claim 17, further comprising:
determining a time at which the first tracking area is added to the first list of tracking areas in response to adding the first tracking area to the first list of tracking areas;
waiting a predetermined period of time from the time at which the first tracking area is added to the first list of tracking areas; and
removing the first tracking area from the first list of tracking areas after waiting the predetermined period of time.

19. The method of claim 1, wherein:
determining whether the identified network supports CSFB operations for the LTE RAT further comprises determining whether the first tracking area is included in a list of tracking areas that support CSFB operations; and
acquiring service from the identified network with the LTE RAT in one of a CSFB mode and an SGLTE mode further comprises acquiring service from the identified network with the LTE RAT in a CSFB mode in response to determining that the first tracking area is included in the list of tracking areas.

20. The method of claim 1, further comprising:
acquiring service from the identified network with the LTE RAT in an SGLTE mode; and
determining whether a call has started on a second GSM RAT associated with a second subscription,
wherein determining whether the identified network supports CSFB operations for the LTE RAT comprises determining whether the identified network supports CSFB operations for the LTE RAT in response to determining that a call has started on the second GSM RAT.

21. The method of claim 20, wherein acquiring service from the identified network with the LTE RAT in one of a CSFB mode and an SGLTE mode based at least in part on the determination of whether the identified network supports CSFB operations comprises maintaining service with the LTE RAT in an SGLTE mode in response to determining that a call has started on the second GSM RAT and determining that the identified network does not support CSFB operations.

22. The method of claim 20, wherein acquiring service from the identified network with the LTE RAT in one of a CSFB mode and an SGLTE mode based at least in part on the determination of whether the identified network supports CSFB operations comprises acquiring service with the LTE RAT in a CSFB mode in response to determining that a call has started on the second GSM RAT and that the identified network supports CSFB operations.

23. The method of claim 22, further comprising:
determining whether the call on the second GSM RAT has ended; and
reacquiring service with the LTE RAT in an SGLTE mode in response to determining that the call on the second GSM RAT has ended.

24. The method of claim 20, further comprising:
suspending acquisition of service with a first GSM RAT associated with the first subscription in response to determining that a call on the second GSM RAT has started; and
resuming acquisition of service with the first GSM RAT in response to determining that the identified network does not support CSFB operations.

25. The method of claim 24, further comprising:
deactivating the first GSM RAT in response to determining that a call has started on the second GSM RAT and that the identified network supports CSFB operations;
determining whether the call on the second GSM RAT has ended; and
reactivating the first GSM RAT and reacquiring service with the first GSM RAT in response to determining that the call on the second GSM RAT has ended.

26. A mobile communication device, comprising:
a plurality of radio-frequency (RF) chains; and
a processor coupled to the plurality of RF chains and a plurality of Subscriber Identity Modules (SIMs), wherein the processor is configured to:
identify a network that is available in a first tracking area associated with a current location of the mobile communication device;
determine whether the identified network supports circuit-switch-fallback (CSFB) operations for a Long Term Evolution (LTE) radio access technology (RAT) associated with a first subscription; and
acquire service from the identified network with the LTE RAT in one of a CSFB mode and a simultaneous Global System for Mobile Communications (GSM)/LTE (SGLTE) mode based at least in part on the determination of whether the identified network supports CSFB operations.

27. The mobile communication device of claim 26, wherein the processor is further configured to acquire service from the identified network with the LTE RAT in a CSFB mode in response to determining that the identified network supports CSFB operations for the LTE RAT.

28. The mobile communication device of claim 26, wherein the processor is further configured to acquire service from the identified network with the LTE RAT in an SGLTE mode in response to determining that the identified network does not support CSFB operations for the LTE RAT.

29. The mobile communication device of claim 26, wherein the processor is further configured to:
determine whether the first tracking area is included in a list of tracking areas that do not support CSFB operations; and
acquire service from the identified network with the LTE RAT in an SGLTE mode in response to determining that the first tracking area is included in the first list of tracking areas.

30. The mobile communication device of claim 26, wherein the processor is further configured to:
determine whether the first tracking area is included in a list of tracking areas that support CSFB operations; and
acquire service from the identified network with the LTE RAT in a CSFB mode in response to determining that the first tracking area is included in the list of tracking areas.
